(19) United States
(12) Patent Application Publication
(10) Pub. No.: US 2024/0076143 A1
(43) Pub. Date: Mar. 7, 2024

(54) Robotic Systems for Managing Objects

(71) Applicants: Sarcos Corp., Salt Lake City, UT (US); Changi Airport Group (Singapore) Pte Ltd., Singapore (SG)

(72) Inventors: Allen J. Bancroft, Salt Lake City, UT (US); Alan J. Bandi, Salt Lake City, UT (US); Christopher M. Gardner, Salt Lake City, UT (US); Nicolas Paris, Salt Lake City, UT (US)

(21) Appl. No.: 18/459,373

(22) Filed: Aug. 31, 2023

Related U.S. Application Data
(60) Provisional application No. 63/403,288, filed on Sep. 1, 2022.

(51) Int. Cl. B65G 65/00

(52) U.S. Cl. CPC B65G 65/005

(57) ABSTRACT

An end of arm tool (EOAT) assembly can include a tool base subassembly having a tool base attachment surface as well as a first and second mechanized tool subassembly, each being movably attached to the tool base subassembly along the tool base attachment surface. The mechanized tool subassemblies include an elongated body oriented orthogonally relative to the tool base attachment surface, and a holding member attached to its respective elongated body. The holding members can have an engaged position to pass beneath an object to assist with lifting of the object and a disengaged position that does not contribute to lifting of the object. Movement of the first and second mechanized tool assemblies along the tool base attachment surface can provide for opening and partially closing of a gap there between to laterally provide space for engaging with the object followed by squeezing the object for lifting.

The present application claims the benefit of U.S. Provisional Patent Application No. 63/403,288 filed on Sep. 1, 2022, the entirety of which is incorporated herein by reference.

### BACKGROUND

Airports, shipping ports, warehouses, and many other similar commercial ground operations face several challenges, including tight apron space, manpower shortage, inconsistent operational performance, and/or poor resilience against operation disruption. As airports and many of these other commercial ground operations get busier and face growing traffic or throughput, these challenges may potentially cause more operational issues. Various approaches to mitigating these challenges have included the use of digital technology to improve efficiency and performance of operations through improved communication and oversight, and improved object handling and/or management, e.g., baggage handling, etc. For example, suction methods have been used to aid in picking up or otherwise moving and placing objects, such as baggage. In other systems, rollers and/or conveyor belts have been used to provide for the lateral movement of objects. These various solutions can provide some manpower relief, but digital operational technology may be more susceptible to disruptions such as inclement weather, suction methods for picking and placing baggage may not work in all cases and do not save significant manpower, and rollers/conveyor belt systems also utilize significant manpower in loading and unloading objects.

### BRIEF DESCRIPTION OF THE DRAWINGS

FIG. 1A is a perspective view of an example of a robotic system for managing objects in accordance with the present disclosure;

FIG. 1B is a side plan view of an example robotic system for managing objects in accordance with the present disclosure;

FIG. 2A is a perspective view of an example of an object managing system in accordance with the present disclosure;

FIG. 2B is a side plan view of an example EOAT assembly of an object managing system in accordance with the present disclosure;

FIG. 3A is a side schematic view of an example object managing system in accordance with the present disclosure;

FIG. 3B is a top schematic view of an example object managing system in accordance with the present disclosure;

FIG. 4A is a perspective view of an example of an end of arm tool (EOAT) assembly in accordance with the present disclosure;

FIG. 4B is a partial perspective view of the mechanized tool subassembly of the end of arm tool (EOAT) assembly of FIG. 4A in accordance with the present disclosure;

FIG. 4C is a bottom plan view of an example of an end of arm tool (EOAT) assembly holding an object in accordance with the present disclosure;

FIG. 4D is a side plan view of an example of an end of arm tool (EOAT) assembly associated with a conveyer belt in accordance with the present disclosure;

FIG. 4E is a rear plan view of an example of an end of arm tool (EOAT) assembly associated with a conveyer belt in accordance with the present disclosure;

FIG. 4F is an enlarged side view taken from a portion of FIG. 4D illustrating a holding member joint associated with a conveyer belt in accordance with the present disclosure;

FIG. 4G is an enlarged side view taken from a portion of FIG. 4E illustrating a holding member in a horizontal position;

FIG. 4H is a rear plan view of an example of an end of arm tool (EOAT) assembly associated with a conveyer belt in accordance with the present disclosure;

FIG. 4J is an enlarged side view of the holding member joint associated with the conveyer belt shown in FIG. 4F with the holding member in a vertical disengaged position in accordance with the present disclosure;

FIG. 4K is an enlarged side view of the holding member shown in FIG. 4G in a vertical disengaged position in accordance with the present disclosure;

FIG. 5A is a perspective view of an example of a robotic system for managing objects with multiple object managing systems in accordance with the present disclosure;

FIG. 5B is a top plan view of an example of a robotic system for managing objects with multiple object managing systems in accordance with the present disclosure;

FIG. 6 is a schematic diagram of an example computing device or system usable with the robotic systems or assemblies, subassemblies, or subsystems thereof in accordance with of the present disclosure; and

FIG. 7 is a schematic diagram of example robotic system controllers and structures usable in in accordance with the present disclosure.

### DETAILED DESCRIPTION

In accordance with the present disclosure, robotic systems for managing objects, end of arm tool (EOAT) assemblies, methods of robotically managing objects, and/or the like may provide solutions for object management, which may include robotics with positions at a fixed location, or may include mounting the robotics on a mobile carrier, e.g., a vehicle, providing a mobile robotic system for managing objects. In additional detail, the robotics system may include one or more end of arm tool assemblies, and/or the robotic system may be equipped to operate with a conveyer system, e.g. conveyer belt(s) and/or cylindrical rotatable members, etc.

In accordance with examples of the present disclosure, an EOAT assembly can include a tool base subassembly having a tool base attachment surface, a first mechanized tool subassembly, and a second mechanized tool subassembly. The first mechanized tool subassembly can be movably attached to the tool base subassembly along the tool base attachment surface, and can include a first elongated body oriented orthogonally relative to the tool base attachment surface and a first holding member attached to the first elongated body. The first holding member can have an engaged position to pass beneath an object to assist with lifting of the object and a disengaged position that does not contribute to lifting of the object. The second mechanized tool subassembly can likewise be movably attached to the tool base subassembly along the tool base attachment surface, and can include a second elongated body oriented orthogonally relative to the tool base attachment surface and a second holding member attached to the second elongated body. The second holding member can have an engaged position to pass beneath an object to assist with lifting of the object and a disengaged position that does not contribute to lifting of the object. In examples herein, movement of first and second mechanized tool assemblies along the tool base attachment surface can provide for opening and partially closing of a gap there between to laterally provide space for engaging with the object followed by squeezing the object for lifting. In some examples, the tool base subassembly can be connected to an arm assembly of an object managing system. In other examples, a first horizontal motion subsystem can be included to selectively move the first elongated body along the tool base attachment surface between a first end of the tool base subassembly toward a center region of the tool base subassembly. Likewise, a second horizontal motion subsystem can be included to selectively move the second elongated body along the tool base attachment surface between a second end of the tool base subassembly toward the center region of the tool base subassembly. The EOAT assembly can also include a first holding member joint connecting the first elongated body to the first holding member such that articulation of the first holding member joint transitions the first holding member between its engaged position and it disengaged position. Likewise, a second holding member joint can be included connecting the second elongated body to the second holding member such that articulation of the second holding member joint transitions the second holding member between its engaged position and it disengaged position. The EOAT assembly can further include a first lifting member secured to the first elongated body and adjacent to a first opening through the first elongated body such that the first lifting member is movable relative to the first opening to: protrude or protrude further through the first opening or cause a first lifting assist member to protrude or protrude further into the gap to assist with object engagement for lifting. Rotation of the first lifting member cause the first lifting assist member to protrude or protrude further into the gap, for example. Likewise, a second lifting member can be secured to the second elongated body and adjacent to a second opening through the second elongated body such that the second lifting member is movable relative to the second opening to: protrude or protrude further through the second opening or cause a second lifting assist member to protrude or protrude further into the gap to assist with object engagement for lifting. In some examples, rotation of the second lifting member can cause the second lifting assist member to protrude or protrude further into the gap.

In another example, a robotic system for managing objects can include an EOAT assembly including holding members having an engaged position to pass beneath an object to assist with lifting of the object and a disengaged position that does not contribute to lifting of the object, and a conveyer system. The conveyer system can include a plurality of conveyer belt supports to support objects placed thereon, and conveyer belt support spacing between adjacent conveyer belt supports. The conveyer belt support spacing may be configured to receive holding members in both the engaged and the disengaged position such that the holding members may be placed beneath the objects on the conveyer belt supports for lifting. The conveyer system can also include at least one rotatable drive member, and a conveyer belt engaged with the rotatable drive member to generate conveyer belt movement along a working surface of the conveyer belt. The conveyer belt may be narrower in a direction orthogonal to the direction of belt movement compared to the conveyer belt supports to provide access for the holding members into the conveyer belt support spacing. In some examples, the EOAT assembly can further include a pair of mechanized tool assemblies to provide coordinated lateral movement for opening a gap there between to laterally provide space for engaging with an object and partially closing the gap to squeeze the object for lifting. In other examples, the pair of mechanized tool assemblies each include at least one of the holding members associated therewith, wherein lifting is configured to occur when the pair of mechanized tool assemblies is squeezing the object laterally and the holding members are in the engaged position beneath the object. The robotic system can also include a tool base subassembly such that the pair of mechanized tool assemblies are each connected orthogonally to the tool base subassembly for lateral translation along a tool base attachment surface of the tool base assembly causes the opening and partial closing of the gap. One or both of the pair of mechanized tool assemblies may include an opening therethrough for engagement of a lifting member or a lifting assist member as one or both protrude or protrude further into the gap. The EOAT assembly may be rotationally connected to an arm assembly, for example. The arm assembly can include multiple arm segments and multiple arm joints to provide three-dimensional manipulation of the EOAT assembly. In further detail, the arm assembly an also be connected at or near at an opposite end thereof to an arm assembly connector of vertical assembly to provide vertical movement of the arm assembly. In some examples, the vertical assembly can be rotational attached to a support base. In other examples, the support base can be on a mobile vehicle. Furthermore, the robotic system can include a second EOAT assembly. The second EOAT assembly may also include holding members having an engaged position to pass beneath an object to assist with lifting of the object and a disengaged position that does not contribute to lifting of the object, and/or a pair of mechanized tool assemblies to provide coordinated lateral movement for opening a gap there between to laterally provide space for engaging with an object and partially closing the gap to squeeze the object for lifting. One or both of the pair of mechanized tool assemblies can include an opening therethrough for engagement of a lifting member or a lifting assist member as one or both protrude or protrude further into the gap. The EOAT assembly and the second EOAT assembly may be configured as mirror images of one another. In still other examples, the EOAT assembly and the second EOAT assembly can both be positioned on a mobile vehicle.

In another example, a method of managing objects can include identifying an object on a surface to be manipulated by an EOAT assembly of a robotic system, and orienting a pair mechanized tool subassemblies about an object. The pair of mechanized tool subassemblies can each include one or more holding members having an engaged position and a disengaged position. Prior to engaging the object, the holding members can be in the disengaged position. In further detail, the method can include squeezing the object between the pair of mechanized tool subassemblies, moving the holding members from the disengaged position to the engaged position, and manipulating the object while squeezed between the pair of mechanized tool subassemblies and while the holding members are positioned beneath the object to provide support thereto. In some examples, the EOAT assembly can include a tool base subassembly having a tool base attachment surface such that squeezing the object occurs by coordinated lateral movement of the pair of mechanized tool subassemblies to partially closing a gap there between. The pair of mechanized tool subassemblies can each include at least one of the holding members associated therewith such that manipulating the object may occur when the pair of mechanized tool subassemblies is squeezing the object laterally and the holding members are in the engaged position beneath the object. The EOAT assembly can also include a tool base subassembly such that the pair of mechanized tool assemblies are each connected orthogonally to the tool base subassembly for lateral translation along a tool base attachment surface of the tool base assembly causes the opening and partial closing of the gap. One or both of the pair of mechanized tool assemblies may include an opening therethrough such that manipulating the object is assisted by engagement of a lifting member or a lifting assist member as one or both protrude or protrude further into the gap. Orienting the pair of mechanized tool subassemblies may include one or all of rotating the EOAT assembly relative to an arm assembly, moving multiple arm segments of the arm assembly at arm joints, moving the arm assembly vertically along a vertical assembly, and/or rotating the vertical assembly relative to a support base. Combining these orienting actions can provide for three-dimensional manipulation of the EOAT assembly, for example. In some examples, the EOAT assembly can be connected to a mobile vehicle and orienting the pair of mechanized tool subassemblies includes moving the mobile vehicle in proximity to one or more objects to be manipulated.

In the following detailed description, reference is made to the accompanying drawings which form a part hereof. The processes and system described in the detailed description and drawings are for illustrative purposes and are not meant to be limiting. Other embodiments can be utilized and other changes can be made, without departing from the scope of the disclosure presented herein. Furthermore, the depiction of a given apparatus, assembly, structure, system, method, or the like herein uses common reference numbering for ease of understanding and continuity. Thus, not all reference numbers are identified in every figure. Likewise, not all reference numbers appearing in a figure may be described in the context of the figure in which it is shown. For example, for clarity and to avoid significant redundancy, reference numbers may be present in figures so that multiple views of a feature may provide better understanding of the disclosure, even if not specifically described in the context of a particular figure. Additionally, the drawings are provided by way of example, and thus, the structures shown or other structures that provide the same or similar functions may be substituted therewith without departing from the scope of the present disclosure. It is noted that the example drawings may or may not be to scale.

It is to be understood that, while examples are mostly described in the present disclosure as pertaining to systems and methods for lifting and transporting baggage, the principles described in the present disclosure may also be applied beyond the context of loading and offloading, and picking and placing, such as cargo, building materials, parcels, boxes, bags, furniture, smaller objects, larger objects, or the like without departing from the teachings of the present disclosure.

It is also to be understood that, while examples are mostly described in the present disclosure as applying to lifting and transporting baggage to and from a belt or conveyor, the principles described in the present disclosure may also have other applications such as unloading baggage, boxes, parcels, and other objects from an airplane or other carrier vehicle and loading a baggage or similar trolley or vice versa, picking and placing objects in a manufacturing process, or moving and arranging building materials or similar objects.

The present disclosure relates generally to robotic systems and methods for managing objects. In some examples, the present disclosure relates to robotic systems and methods for lifting and transporting objects, including luggage, boxes, cargo, building materials, parcels, boxes, bags, furniture, etc. Examples will now be described below with reference to the accompanying figures, which form a part of the present disclosure.

Robotic Systems for Managing Objects

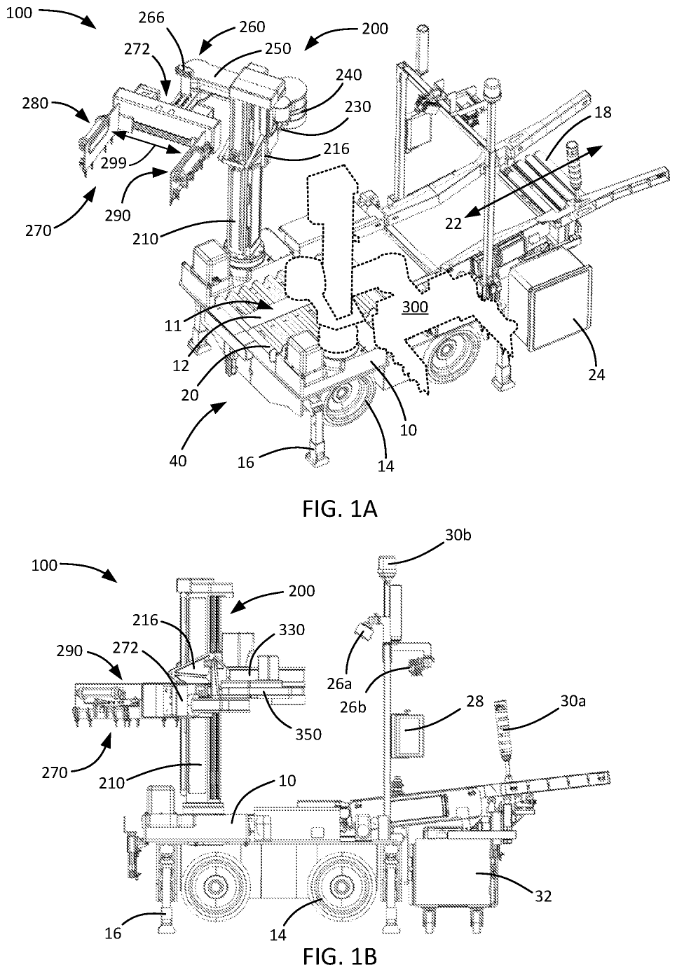

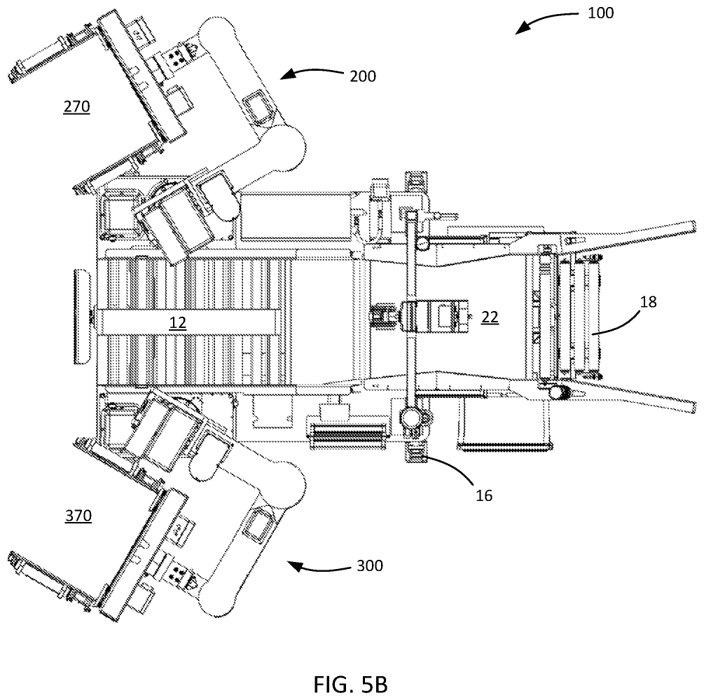

FIG. 1A (perspective view) and FIG. 1B (side plan view) illustrate example robotic systems for managing objects 5000. The robotic system 100 in this example may include a support body 10 and a first object managing system 200. The robotic system 100 may also include one or more other object managing systems, such as a second object managing system, shown in phantom lines at 300, but shown in greater detail hereinafter at FIGS. 5A and 5B. In examples in which the robotic system 100 includes a first object managing system 200 and second object managing system 300, the first object managing system 200 may be identical to (or a mirror image of) the second object managing system 300, or the first and second object managing systems may be different, e.g., different end of arm tool assemblies, different manipulation architecture, etc. In further detail, the robotic system may also include one or more controllers (not shown) to control the robotic system by manual control, by automation, and/or by both manual control and automation.

In an example, a support body 10 may include and/or be formed as a movable vehicle, movable base, secured base, e.g., secured and/or securable to the ground, or the like. In the examples shown herein and without limitation, it is noted that the robotic system is typically shown as being present on a movable vehicle for continuity and consistency, but in some instances, the mobility of the robotic system may not be a feature that is desirable or practical. The support body 10 may include a working surface 11 that may carry a conveyer system, such as one or more conveyer belts 12 (and/or any other assemblies that enable an object 50 to move along a surface of the support body 10). The support body 10 may also carry other elements for transport of objects, such as a plurality of cylindrical rotatable members 18, e.g., rollers, which are shown in parallel to one another for lateral movement of objects. However, other arrangements can be likewise used for the conveyer system, including conveyer belt 12 and/or rollers 18, etc., that are arranged for rotational object movement, vertical object movement, inclined object movement, etc. For purposes of clarity, the examples shown in the drawings typically depict conveyer systems that provide for lateral object movement along a pathway 22 with some incline. As shown in this, there may be an air box 24 to provide functionality to components of the robotic system 100.

In further detail, if the robotic system 100 is a mobile robotic system as shown, the support body 10 may also include wheels 14 (and/or any other assemblies that enable the support body 10 to move along the ground). The support body 10 may also include one or more stabilizing assemblies 16 (and/or any other assemblies that enable the support body 10 to be secured to, anchored to, and/or immovable relative to the ground). This can provide ease of mobility, and when in place for operation, enhanced safety and performance can be achieved by stabilizing the location of the robotic system, particularly when operating with heavy object loads. The presence of wheels 14 and stabilizing assemblies 16 may be modified for other applications, such as for operation on a track or rail system, operation on a water vessel, air operation, high altitude or space operation, etc. Additional features that may be included on the robotic system 100 include perception sensors 26a and 26b positioned on the mobile vehicle 40 in the example shown, as well as another perception sensor 266, e.g., vision sensing camera(s), positioned on the EOAT assembly 270. In some examples, there may also be a display or control interface 28 for inputting and/or receiving information regarding the robotic system 100, as well as various safety features, such as sound emitters 30a, light emitters 30b, etc. A power source 32 is also shown at FIG. 1B, which in this example is a battery dolly arrangement.

As mentioned, the robotic systems for managing objects may be equipped with object managing systems 200 and 300. In this example, a first object managing system 200 is shown that may include one or more vertical assemblies 210, one or more arm assemblies 220, and one or more end of tool (EOAT) assemblies 270. A second object managing system 300 is shown in phantom lines in FIG. 1A for clarity in showing the features of the first object managing system 200, but shown in greater detail in FIGS. 5A and 5B hereinafter.

It is noted that many structures are described herein in terms of “first,” “second,” “third,” and so forth. In some instances, no mention of “first,” “second,” “third,” and so forth is used. Since the features may be similar on various object managing systems 200 and 300, these descriptions can be considered to be applicable to other object managing systems as if described in full. For example, in describing an arm assembly (or first arm assembly 220) in the context of an object managing system (or first object managing system 200), as shown in FIGS. 1A and 1B, that description is relevant and incorporated by reference with respect to the description of a second arm assembly notated as second arm assembly 300 as found in FIGS. 5A and 5B.

Returning now to FIGS. 1A and 1B, a vertical assembly 210 is shown that may include one or more arm assembly connectors 216, one or more support rotary subsystems 211, and/or one or more vertical motion subsystems 217. In further detail, an arm assembly 220 may include a proximal arm segment 230, a proximal joint 240, a proximal joint driving subsystem 241, a distal arm segment 250, a distal joint 260, and a distal joint driving subsystem 261. Although the present disclosure may describe the arm assembly 220 as including one proximal arm segment 230, one proximal joint 240, one proximal joint driving subsystem, one distal arm segment 250, one distal joint 260, and one distal joint driving subsystem, it is to be understood that examples of the arm assembly 220 may include more or less than one proximal arm segment 230, more or less than one proximal joint 240, more or less than one proximal joint driving subsystem, more or less than one distal arm segment 250, more or less than one distal joint 260, and/or more or less than one distal joint driving subsystem without departing from the teachings of the present disclosure.

Referring now to the end of arm tool (EOAT) assembly 270 shown in FIGS. 1A and 1B (or 370 in FIGS. 5A and 5B), these assemblies may include, for example, a tool base subassembly 272, a first mechanized tool subassembly 280, and a second mechanized tool subassembly 290. In this example, the tool base subassembly 272 may include a first subassembly member connector 274, a second subassembly member connector 276, a first horizontal motion subsystem 278, and a second horizontal motion subsystem 279. These horizontal motion subsystems can be located at any location, but are shown as being housed near their respective mechanized tool subassemblies. Although the present disclosure may depict the tool base subassembly 272 in this example as including one first subassembly member connector 274, one second subassembly member connector 276, one first horizontal motion subsystem 278, and one second horizontal motion subsystem 279, it is to be understood that examples of the tool base subassembly 272 may include more or less of these components.

Regarding the first mechanized tool subassembly 280, this structure may include a first holding member 282, a first holding member joint 284, a first tool rotary subsystem 283, a first opening 285, a first lifting member 286, a first lifting member rotary subsystem 287, and a first lifting assist member 288. Although the present disclosure may describe the first mechanized tool subassembly 280 as including one first holding member 282, one first holding member joint 284, one first tool rotary subsystem 283, one first opening 285, one first lifting member 286, one first lifting member rotary subsystem, and one first lifting assist member 288, it is to be understood that examples of the first mechanized tool subassembly 280 may include more or less of these components without departing from the teachings of the present disclosure.

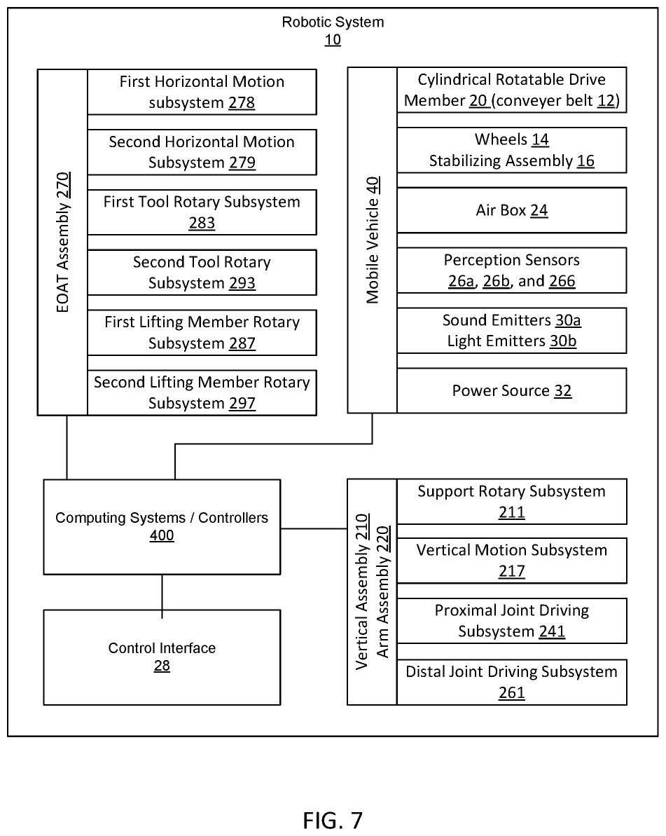

Also shown is a second mechanized tool subassembly 290, which may include a second holding member 292, a second holding member joint 294, a second tool rotary subsystem 293 (not shown, but shown in FIG. 7), a second opening 295, a second lifting member 296, a second lifting member rotary subsystem (not shown), and a second lifting assist member 298. Although the present disclosure may describe the second mechanized tool subassembly 290 as including one second holding member 292, one second holding member joint 294, one second tool rotary subsystem 293, one second opening 295, one second lifting member 296, one second lifting member rotary subsystem, and one second lifting assist member 298, it is to be understood that examples of the second mechanized tool subassembly 290 may include more or less of these components without departing from the teachings of the present disclosure.

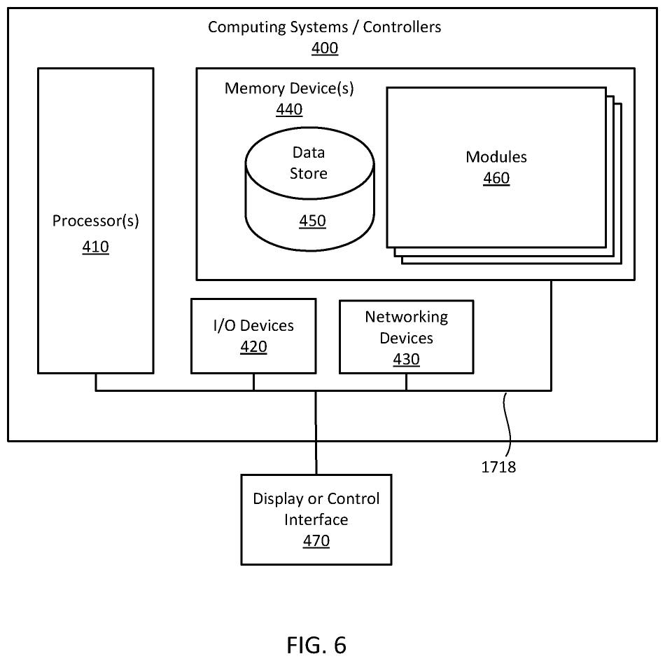

In accordance with additional examples, a controller (not shown) may be present, and include any number of combinations of components and/or software/firmware, including any processor, server, system, device, computing device, controller, microprocessor, microcontroller, microchip, semiconductor device, artificial intelligence (AI), machine learning, deep learning, or the like, configurable or configured to perform or enable autonomous, semi-autonomous, and/or user-controller managing, including controlling, of one or more elements, aspects, functionalities, operations, and/or processes of the robotic system 100. For example, the controller may be configurable or configured to manage and/or control one or more elements, aspects, functionalities, operations, and/or processes of the support body 10. Alternatively or in addition, the controller may be configurable or configured to manage and/or control one or more elements, aspects, functionalities, operations, and/or processes of the vertical assembly 210. Alternatively or in addition, the controller may be configurable or configured to manage and/or control one or more elements, aspects, functionalities, operations, and/or processes of the arm assembly 220. Alternatively or in addition, the controller may be configurable or configured to manage and/or control one or more elements, aspects, functionalities, operations, and/or processes of the second arm assembly. Alternatively or in addition, the controller may be configurable or configured to manage and/or control one or more elements, aspects, functionalities, operations, and/or processes of the EOAT assembly 270. Alternatively or in addition, the controller may be configurable or configured to manage and/or control one or more elements, aspects, functionalities, operations, and/or processes of a second (and/or third, fourth, etc.) EOAT assembly 370, as shown in FIGS. 5A and 5B. Additional detail regarding control of the systems of the present disclosure is provided hereinafter at FIGS. 6 and 7.

Support Bodies

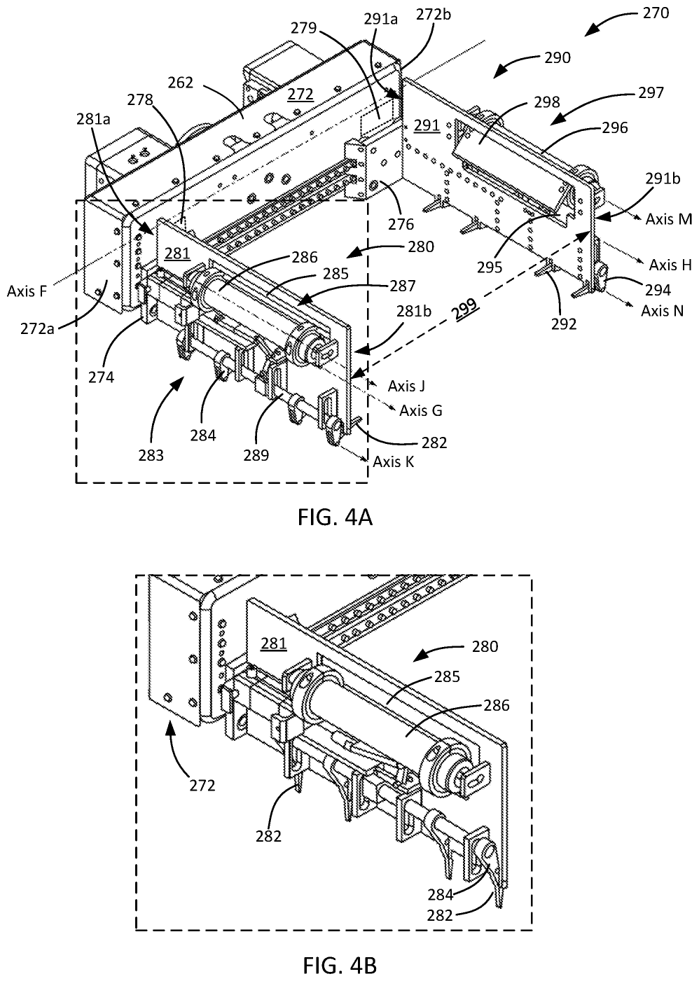

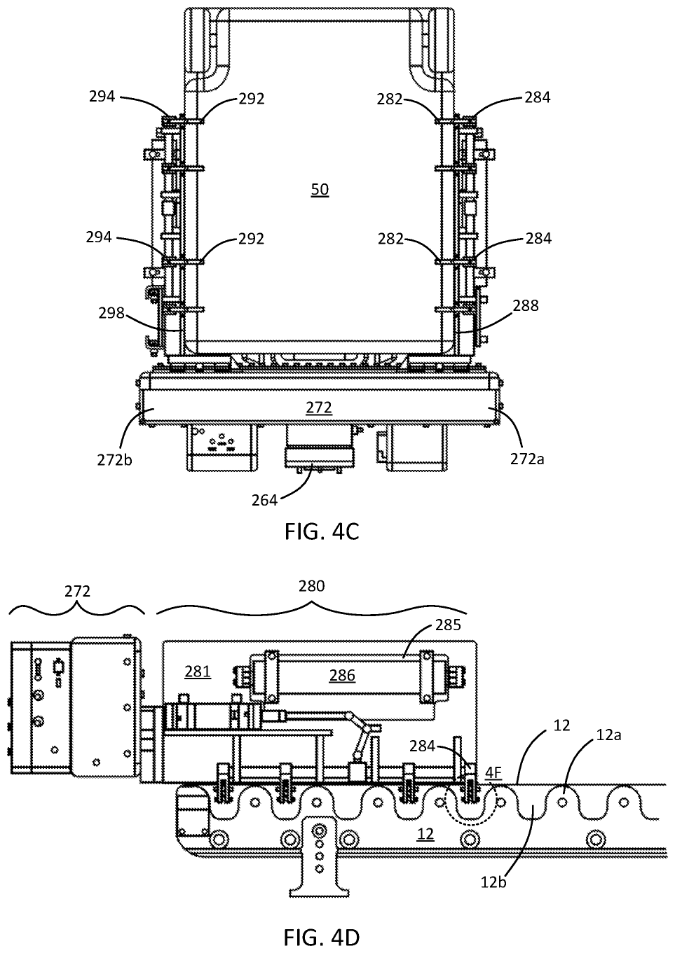

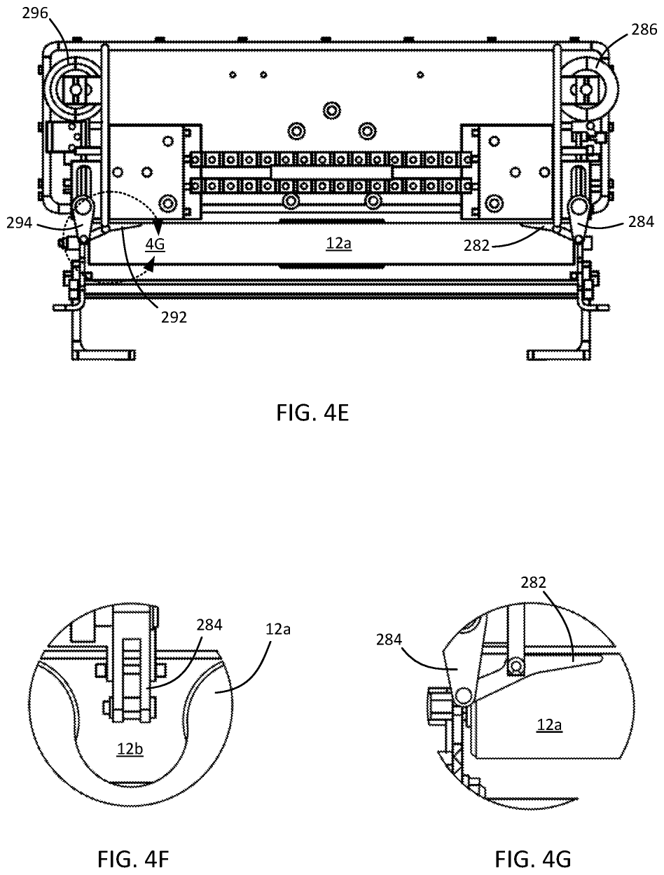

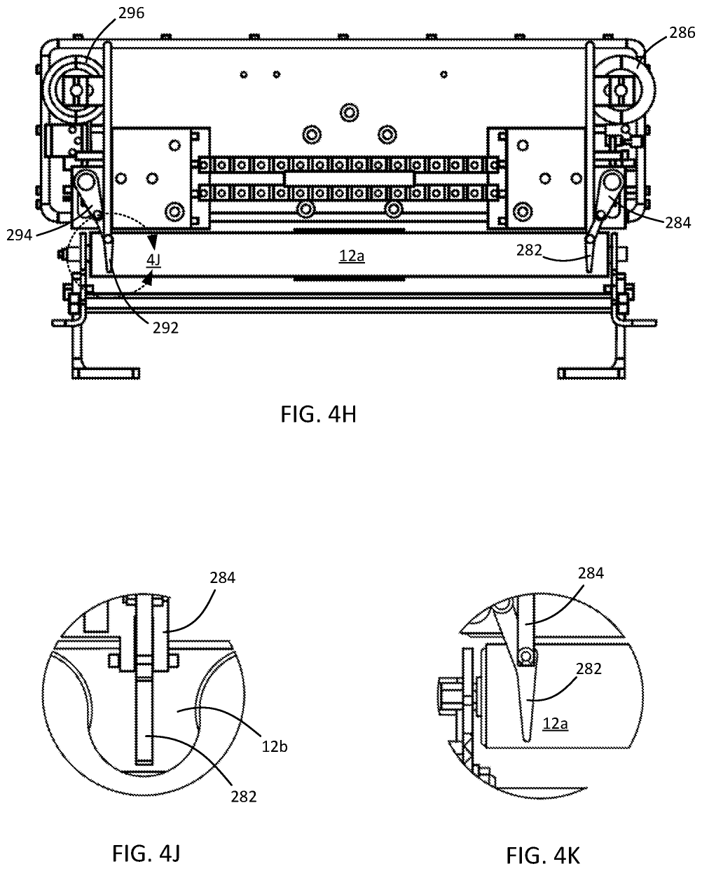

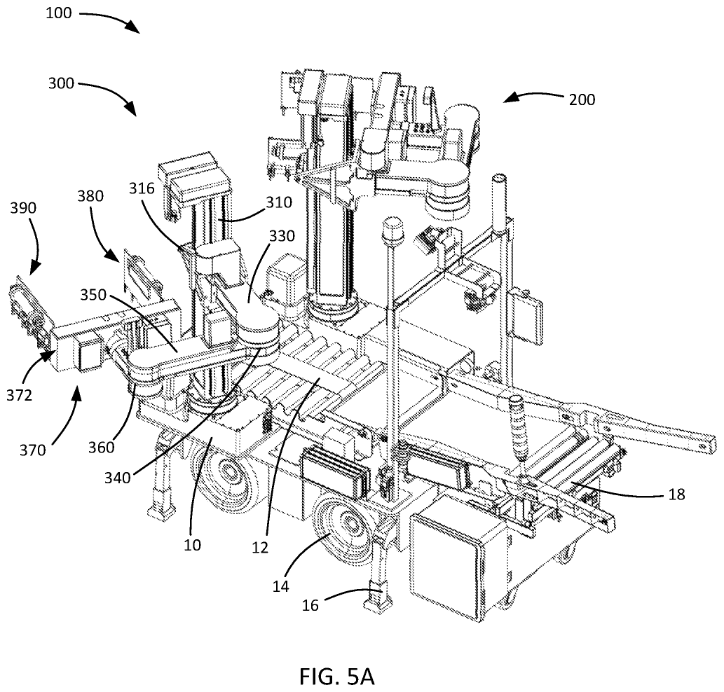

The robotic system 100 can include one or more support bodies 10, which may be formed as a movable vehicle, movable base, secured or immovable base, e.g., secured and/or securable to the ground, or the like. The support body 10 can be configured to have sufficient weight, shape, form, securing, and/or anchoring to support, counter, and/or withstand operations of the rest of the robotic system 100, including any objects 50 (shown in FIG. 4C) that are being managed, lifted, held, and/or transported by one or more components of the robotic system 100. In additional detail, the support body 10 may carry a conveyer system and/or platforms, for example, such as one or more conveyer belts 12 for positioning, orienting, and/or moving one or more objects to a location on a surface of the support body 10, e.g., a “pick-up location” at which the EOAT assembly 270 can be positioned to pick up, hold, lift, secure, grasp, or the like any objects suitable for the configuration of the robotic system 100.

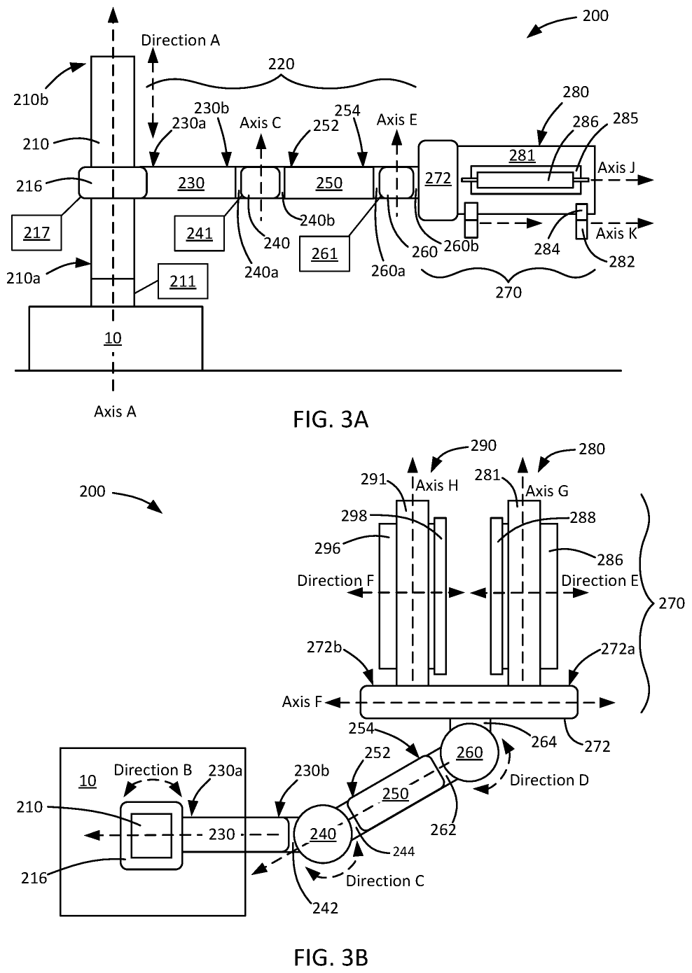

Regarding the conveyer system, it is to be understood in the present disclosure that any other assembly, mechanism, structure, configuration, or the like may be used in addition to or in replacement of a conveyer belt 12 or cylindrical rotatable members 18, which may be cylindrical rotatable drive members 20, without departing from the teachings of the present disclosure. In some examples, the support body 10 can also carry a plurality of cylindrical rotatable members 18 arranged in parallel to one another or in any other configuration to direct movement of the objects placed thereon. Thus, there may be both a conveyer belt 12 as well as the cylindrical rotatable members 18 working together in some instances. In further detail, the conveyer belt 12 may also include one or more conveyer belt spacing 12b between conveyer belt supports 12a (see at least FIGS. 4D, 4F, and 4J). The conveyer belt may be driven, for example, by at least one cylindrical rotatable drive member 20, which may be mechanically driven and which may be different than any freely rotatable cylindrical rotatable members 18 that may be present. In this example, the conveyer belt spacing 12b may be formed as to allow at least one holding member 282 to pass through and/or rotate relative to the holding member joint Axis (see Axis K as illustrated in at least FIG. 3A as well as conveyer belt spacing 12b shown in FIG. 4J) when the EOAT assembly 270 is positioned at the pick-up location.

The support body 10 may also include wheels 14 to enable the support body 10 to move between locations, e.g., to a location where baggage is brought down from an aircraft via a conveyer belt 22. The support body 10 may also include one or more stabilizing assemblies 16 for securing, anchoring, and/or preventing movement and/or changes in orientation of the support body 10. As illustrated in FIG. 1A, a non-limiting example of the support body 10 may be formed as a vehicle having wheels 14 and a conveyer belt 12. It is to be understood in the present disclosure that any other assembly, mechanism, configuration, or the like may be used in addition to or in replacement of wheels and/or stabilizing assembly without departing from the teachings of the present disclosure.

Object Managing Systems

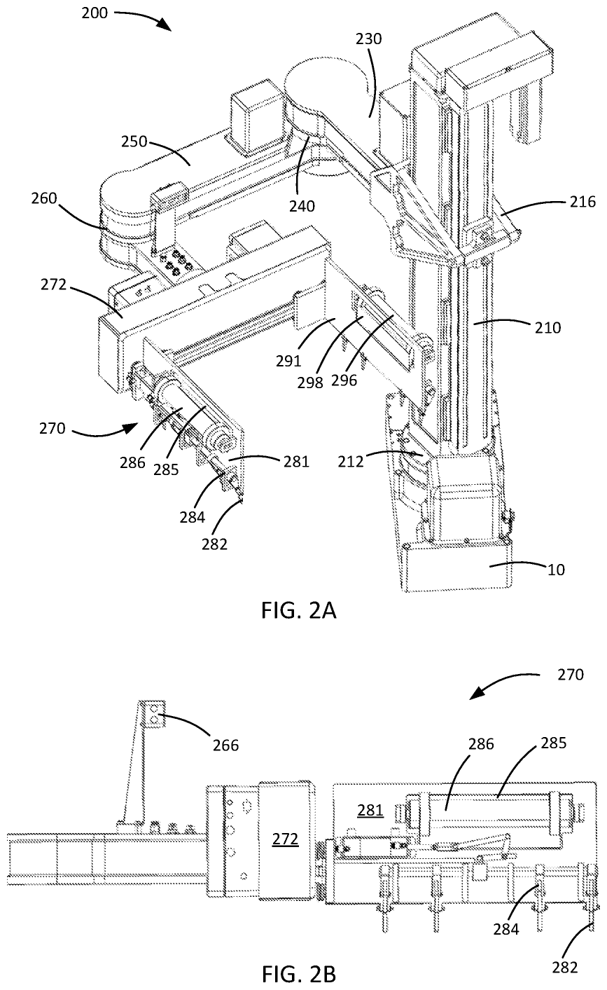

In accordance with the present disclosure, there can be one or multiple object managing systems, namely a first object managing system 200 as shown in FIGS. 1A-3B, and in some examples, there may be a second object managing system (shown at 300 in FIGS. 1A, 5A, and 5B hereinafter). Referring now more specifically to FIG. 2A and FIG. 2B, and for further clarity, to schematic drawings FIGS. 3A and 3B, a first object managing system 200 (or object managing system 200) is shown in greater detail. The object managing system 200 in this example may be configurable or configured to secure to at least a portion of a support body, shown in part at 10. Once secured to the support body 10, the object managing system 200 may be configurable or configured to autonomously, semi-autonomously, and/or be controlled to manage one or more objects.

More specifically, the object managing system 200 in this example includes one or more vertical assemblies 210. As will be further described in the present disclosure, the vertical assembly 210 is configurable or configured to enable the object managing system 200 to provide at least 2 degrees of freedom (DOF) of movement for the EOAT assembly 270, which may be provided by Direction A in FIG. 3A and Direction B in FIG. 3B, for example. The object managing system 200 may also include one or more arm assemblies 220. As will be further described in the present disclosure, the arm assembly 220 may be configurable or configured to enable the first object managing system 200 to provide at least 2 degrees of freedom (DOF) of movement for the EOAT assembly 270, which may be provided in Direction C and Direction D in FIG. 3B, for example. The object managing system 200 may also include multiple end of tool (EOAT) assemblies (not shown). As will be further described in the present disclosure, the EOAT assembly 270 is configurable or configured to hold, lift, secure, grasp, or the like, one or more objects.

Vertical Assemblies

In accordance with the present disclosure, there can be one or multiple vertical assemblies, namely a first vertical assembly 210 and in some instances, a second vertical assembly (shown at 300 in 5A and 5B hereinafter. In greater detail regarding the first vertical assembly 210 (or vertical assembly 210) as shown in detail in FIGS. 2A-3B, the vertical assembly 210 may be configurable or configured to enable the first object managing system 200 to provide at least 2 degrees of freedom (DOF) of movement for the EOAT assembly 270, including vertical movements in Direction A along the vertical Axis A (see at least FIG. 3A) and rotary or rotational movements in Direction B relative to vertical Axis A (see at least FIG. 3B). In some examples, the vertical assembly 210 may include or be formed as an elongated body 210 with a first end 210a and a second end 210b. Vertical Axis A (see at least FIG. 3A) is formed through the elongated body of the vertical assembly 210 between the first end 210a and the second end 210b. The first end 210a of the vertical assembly 210 is configurable or configured to secure the vertical assembly 210 to at least a portion of the support body 10. Once secured, the support body 10 serves as a base, anchor, or the like, for the vertical assembly 210 and the other elements of the first object managing system 200. In some examples, the vertical assembly 210 can be arranged in such a way that its own central Axis A is vertical and orthogonal to a central Axis of the support body 10, e.g., orthogonal to a horizontal Axis formed through the support body 10. However, the vertical assembly 210 may also be arranged in such a way that its own central Axis A is not exactly vertical and not orthogonal to the central Axis of the support body 10, e.g., not orthogonal to a horizontal Axis formed through the support body 10, without departing from the teachings of the present disclosure. In other examples, the vertical assembly 210 can include one or more arm assembly connectors 216, one or more support rotary subsystems 211, and one or more vertical motion subsystems 217. The arm assembly connector 216 may be used to secure an arm assembly 220 to the vertical assembly 210. Once secured, the vertical motion subsystem 217 and/or the support rotary subsystem 211 of the vertical assembly 210 are then configurable or configured to move the arm assembly 220 in Directions A and/or B, respectively.

Arm Assembly Connectors

In accordance with the present disclosure, there can be one or multiple arm assembly connectors, namely a first arm assembly connect 216 and in some instances, a second a second arm assembly connector (shown at 316 in 5A and 5B hereinafter). As illustrated in at least FIGS. 2A-3B, an example of the vertical assembly 210 includes one or more first arm assembly connectors 216 (or arm assembly connectors 216). The arm assembly connector 216 is configurable or configured to secure, at one end, to a portion of the elongated body of the vertical assembly 210. The arm assembly connector 216 is also configurable or configured to secure, at another end, to a first end 230a of the proximal arm segment 230 of the arm assembly 220. In one example, the arm assembly connector 216 is configurable or configured to selectively move (as controlled by the vertical motion subsystem of the vertical assembly 210, as further described in the present disclosure) in a vertical direction between the first end 210a and the second end 210b of the elongated body of the vertical assembly 210. Such vertical movements along the vertical Axis A enable the arm assembly 220 and EOAT assembly 270 to be precisely positioned at (or near) the first end 210a, second end 210b, and/or any location between the first end 210a and the second end 210b so as to manage one or more objects at a plurality of vertical positions (or distances from the ground). Although examples described in the present disclosure are directed to the arm assembly connector 216 selectively movable (via the vertical motion subsystem) between the first end 210a and the second end 210b, it is to be understood that the arm assembly connector 216 may also be configurable or configured to move between other portions, areas, and/or sections of the vertical assembly 210 without departing from the teachings of the present disclosure. For example, the arm assembly connector 216 may be configurable or configured to move between a central region of the vertical assembly 210 and the second end section 210b; between a central region of the vertical assembly 210 and the first end section 210a; etc. In further detail, the arm assembly connector 216 can be also configurable or configured to selectively rotate (as controlled by the support rotary subsystem 211 of the vertical assembly 210, as further described in the present disclosure) around the elongated body of the vertical assembly 210. Such rotary movements around or relative to the vertical Axis A enable the arm assembly 220 and EOAT assembly 270 to be precisely positioned at a plurality of locations within a radius (as limited by the collective length of the serial arrangement of the arm assembly 220 and the EOAT assembly 270) around the vertical assembly 210.

Rotary Subsystems

In accordance with the present disclosure, there can be one or multiple rotary subsystems, namely a first tool rotary subsystem 283 and in some instances, a second tool rotary subsystem 293 (which is part of a second object managing system shown at 300 in FIGS. 5A and 5B). Regarding the first vertical assembly 210, this may include, for example, one or more support rotary subsystems 211. The support rotary subsystem 211 may be any subsystem, device, mechanism, motor, or the like, configurable or configured to selectively rotate the arm assembly connector 216 (and the arm assembly 220 and EOAT assembly 270) in Direction B (see FIG. 3B) around or relative to the vertical Axis A. The support rotary subsystem 211 is configurable or configured to perform such selective rotary movements in Direction B before, while (or during the time in which), and/or after the vertical motion subsystem selectively positions the arm assembly connector 216 at a position along the vertical Axis A between the first end 210a and the second end 210b. For example, the rotary subsystem may be or include a motor assembly configurable or configured to drive the arm assembly connector 216 to selectively rotate around or relative to the elongated body of the vertical assembly 210 so as to position the arm assembly 220 to be precisely directed in any one of a plurality of directions around the vertical Axis A. In further detail, the support rotary subsystem 211 may be housed or provided, in part or in whole, in any location within the robotic system 100. For example, the support rotary subsystem 211 may be housed or provided, in part or in whole, in the vertical assembly 210. As another example, the rotary subsystem may be housed or provided, in part or in whole, in the support body 10.

Vertical Motion Subsystems

In accordance with the present disclosure, there can be one or multiple vertical motion subsystems, namely a first vertical motion subsystem 217 and in some instances, a second vertical motion subsystem (as part of the second object managing system shown at 5A and 5B hereinafter). In further detail, the first vertical assembly 210 may include one or more vertical motion subsystems 217. The vertical motion subsystem 217 may be any subsystem, device, mechanism, motor, or the like, configurable or configured to selectively move the arm assembly connector 216 (and the arm assembly 220 and EOAT assembly 270) in Direction A (see FIG. 3A) along the vertical Axis A between first end 210a and the second end 210b. The vertical motion subsystem 217 may be configurable or configured to perform such selective vertical movements in Direction A before, while (or during the time in which), and/or after the rotary subsystem selectively positions the arm assembly connector 216 in a direction around the vertical Axis A. For example, the vertical motion subsystem 217 may include a motor assembly configurable or configured to drive the arm assembly connector 216 to selectively move between the first end 210a and the second end 210b of the elongated body of the vertical assembly 210 so as to position the arm assembly 220 to be at a precise vertical position. The vertical motion subsystem 217 may be housed or provided, in part or in whole, in any location within the robotic system 100 (shown in FIGS. 1-2). For example, the vertical motion subsystem may be housed or provided, in part or in whole, in the vertical assembly 210. As another example, the vertical motion subsystem 217 may be housed or provided, in part or in whole, in the support body 10.

Arm Assemblies

In accordance with the present disclosure, there can be one or multiple arm assemblies, namely a first arm assembly 220 and in some instances, a second arm assembly (as part of the second object managing system shown at 300 in FIGS. 5A and 5B hereinafter). In greater detail regarding the first arm assemblies 220 (or arm assemblies 220), and as illustrated in at least FIGS. 2A-3B, an example object managing system 200 includes the arm assembly 220 that can be configurable or configured to enable the first object managing system 200 to provide at least 2 degrees of freedom (DOF) of movement for the EOAT assembly 270, including pivotal or rotary movements in Direction C relative to Axis C and pivotal or rotary movements in Direction D relative to Axis E (see at least FIGS. 3A and 3B). The arm assembly 220 includes a plurality of elements, including arm segments and joints. The arm assembly 220 is configurable or configured to secure, at one end, to the arm assembly connector 216 of the vertical assembly 210. The arm assembly 220 is also configurable or configured to secure, at another end, to the EOAT assembly 270. The arm assembly 220 can include a serial arrangement of one or more proximal arm segments 230, one or more proximal joints 240, one or more proximal joint driving subsystems 241, one or more distal arm segments 250, one or more distal joints 260, and one or more distal joint driving subsystems 261. A first end of the proximal arm segment 230 is securable or secured to one or more arm assembly connectors 216 of the vertical assembly 210. Once secured, the vertical motion subsystem 217 and/or the support rotary subsystem 211 of the vertical assembly 210 are then configurable or configured to move the arm assembly 220 in Directions A and/or B, respectively. These elements of the arm assembly 220 will now be further described below with reference to the accompanying figures, which form a part of the present disclosure.

Proximal Arm Segments

In accordance with the present disclosure, there can be one or multiple proximal arm segments, namely a first proximal arm segment 230 and in some instances, a second proximal arm segment (shown at 330 in 5A and 5B hereinafter). The first arm assembly 220 can include one or more proximal arm segments 230 and may include and/or be formed as an elongated body with a first end 230a and a second end 230b. Horizontal Axis B (see at least FIG. 3B) is formed through the elongated body of the proximal arm segment 230 between the first end 230a and the second end 230b. The first end 230a of the proximal arm segment 230 can be configurable or configured to secure to the arm assembly connector 216 of the vertical assembly 210. Once secured, the proximal arm segment 230 is selectively movable in Direction A between the first end 210a and second end 210b and selectively positionable at any position between the first end 210a and the second end 210b. Once secured, the proximal arm segment 230 may also be selectively pivotable or rotatable in Direction B relative to vertical Axis A and also selectively positionable to be directed in any direction around vertical Axis A. In some examples, the proximal arm segment 230 can be arranged in such a way that its own central Axis B is orthogonal to Axis A of the vertical assembly 210. However, it is to be understood that the proximal arm segment 230 may also be arranged in such a way that its own central Axis B is not orthogonal to Axis A of the vertical assembly 210 without departing from the teachings of the present disclosure. Furthermore, the second end 230a of the proximal arm segment 230 can be configurable or configured to secure to a first end 240a of the proximal joint 240. Thus, although the present disclosure illustrates the arm assembly 220 as having one proximal arm segment 230, it is to be understood that the arm assembly 220 may include two or more proximal arm segments 230 connected in a serial and/or parallel arrangement.

Likewise, the example arm assemblies 220 shown in FIG. 2A-3B may also include one or more distal arm segments 250. The distal arm segment 250 may include and/or be formed as an elongated body 250 with a first end 250a and a second end 250b. Horizontal Axis D (see at least FIG. 3B) is formed through the elongated body of the distal arm segment 250 between the first end 250a and the second end 250b. The first end 250a of the distal arm segment 250 can be configurable or configured to secure to the second end 240b of the proximal joint 240. Once secured, the distal arm segment 250 is selectively movable in Direction C relative to vertical Axis C and also selectively positionable to be directed in any direction around vertical Axis C. In examples, the distal arm segment 250 is arranged in such a way that its own central Axis D is orthogonal to Axis A of the vertical assembly 210 and parallel to the central Axis C of the proximal joint 240. However, it is to be understood that the distal arm segment 250 may also be arranged in such a way that its own central Axis D is not orthogonal to Axis A of the vertical assembly 210 and/or not parallel to the central Axis C of the proximal joint 240 without departing from the teachings of the present disclosure. Furthermore, the second end 250a of the distal arm segment 250 is configurable or configured to secure to a first end 260a of the distal joint 260. Although the present disclosure illustrates the arm assembly 220 as having one distal arm segment 250, it is to be understood that the arm assembly 220 may include two or more distal arm segments 250 connected in a serial and/or parallel arrangement

Proximal Joints

In accordance with the present disclosure, there can be one or multiple proximal joints, namely a first proximal joint 240 and in some instances, a second proximal joint (shown at 340 in FIGS. 5A and 5B hereinafter). As illustrated in at least FIGS. 2A-3B, an example first arm assembly 220 includes one or more proximal joints 240 that include a first end 240a and a second end 240b about a central region that can provide for joint movement, e.g., a hinge, pivot, or the like, that allows the second end 240b to pivot or rotate relative to the first end 240a (and allow the first end 240a to pivot or rotate relative to the second end 240b). As illustrated in FIG. 3A in particular, proximal joint 240 includes vertical Axis C formed through the central portion of the proximal joint 240. In this regard, the proximal joint 240 may be configurable or configured in such a way as to allow the second end 240b to pivot or rotate relative to vertical Axis C. Furthermore, the first end 240a is pivotable or rotatable relative to vertical Axis C. In examples, the proximal joint 240 is arranged in such a way that its own central Axis C is orthogonal to Axis B of the proximal arm segment 230. However, it is to be understood that the proximal joint 240 may also be arranged in such a way that its own central Axis C is not orthogonal to Axis B of the proximal arm segment 230 without departing from the teachings of the present disclosure. In some examples, the first end 240a of the proximal joint 240 may be secured to or formed together with the second end 230b of the proximal arm segment 230. Furthermore, the second end 240b of the proximal joint 240 may be secured to or formed together with the first end 250a of the distal arm segment 250.

Proximal Joint Driving Subsystems

In accordance with the present disclosure, there can be one or multiple proximal joint driving subsystems, namely a first proximal joint driving subsystems 241 and in some instances, a second proximal joint driving subsystems (as part of the second object managing system shown at 5A and 5B hereinafter). The proximal joint driving subsystem 241 may be any subsystem, device, mechanism, motor, or the like, configurable or configured to selectively rotate the second end 240b of the proximal joint (and the distal arm segment 250 and EOAT assembly 270) in Direction C (see FIG. 3B) around or relative to the vertical Axis C. For example, the proximal joint driving subsystem may be or include a motor assembly configurable or configured to drive the distal arm segment 250 (and EOAT assembly 270) to selectively rotate around or relative to the vertical Axis C so as to position the distal arm segment 250 and EOAT assembly 270 to be precisely directed in any one of a plurality of directions around the vertical Axis C. The proximal joint driving subsystem may be housed or provided, in part or in whole, in any location within the robotic system 100. For example, the proximal joint driving subsystem may be housed or provided, in part or in whole, in the arm assembly 220. As another example, the proximal joint driving subsystem may be housed or provided, in part or in whole, in the vertical assembly 210. As another example, the proximal joint driving subsystem may be housed or provided, in part or in whole, in the support body 10.

Distal Joints

In accordance with the present disclosure, there can be one or multiple distal joints, namely a first distal joint 260 and in some instances, a second distal joint (shown 360 in FIGS. 5A and 5B hereinafter). As also illustrated in at least FIGS. 2A-3B, an example of the first arm assembly 220 (or arm assembly 220) can include one or more distal joints 260 that include a first end 260a, a second end 260b, and a central region that provides for actuation, e.g., a hinge, pivot, or the like, allowing the second end 260b to pivot or rotate relative to the first end 260a (and allow the first end 260a to pivot or rotate relative to the second end 260b). As illustrated in FIG. 3A in particular, distal joint 260 can include vertical Axis E formed through the central region of the distal joint 260. In this regard, the distal joint 260 is configurable or configured in such a way as to allow the second end 260b to pivot or rotate relative to vertical Axis E. Furthermore, the first end 260a is pivotable or rotatable relative to vertical Axis E. In examples, the distal joint 260 is arranged in such a way that its own central Axis E is orthogonal to Axis D of the distal arm segment 250. However, it is to be understood that the distal joint 260 may also be arranged in such a way that its own central Axis E is not orthogonal to Axis D of the distal arm segment 250 without departing from the teachings of the present disclosure. In some examples, the first end 260a of the distal joint 260 may be secured to or formed together with the second end 250b of the distal arm segment 250. Furthermore, the second end 260b of the distal joint 260 may be secured to or formed together with the EOAT assembly 270, e.g., secured to or formed together with a portion of the tool base subassembly 272.

Distal Joint Driving Subsystems

In accordance with the present disclosure, there can be one or multiple distal joint driving subsystems, namely a first distal joint driving subsystem 261 and in some instances, a second distal joint driving subsystem (as part of the second object managing system shown at 300 in FIGS. 5A and 5B hereinafter). The distal joint driving subsystem 261 may include any subsystem, device, mechanism, motor, or the like, configurable or configured to selectively rotate the second end 260b of the distal joint (and the EOAT assembly 270) in Direction D (see FIG. 3B) around or relative to the vertical Axis E. For example, the distal joint driving subsystem 261 may be or include a motor assembly configurable or configured to drive the EOAT assembly 270 to selectively rotate around or relative to the vertical Axis E so as to position the EOAT assembly 270 to be precisely directed in any one of a plurality of directions around the vertical Axis E. The distal joint driving subsystem 261 may be housed or provided, in part or in whole, in any location within the robotic system 100. For example, the distal joint driving subsystem 261 may be housed or provided, in part or in whole, in the arm assembly 220. As another example, the distal joint driving subsystem 261 may be housed or provided, in part or in whole, in the vertical assembly 210. As another example, the distal joint driving subsystem 261 may be housed or provided, in part or in whole, in the support body 10.

End of Arm Tool (EOAT) Assemblies

In accordance with the present disclosure, there can be one or multiple EOAT assemblies, namely a first EOAT assembly 270 and in some instances, a second EOAT assembly (shown 370 in FIGS. 5A and 5B hereinafter). The end of arm tool (EOAT) assemblies 270 shown as part of an object managing system 200 of the present disclosure are illustrated with some level of detail in FIGS. 1A-3B, but the EOAT assemblies are shown in greater detail in FIGS. 4A-4K. Thus, referring now to FIGS. 4A-4K more specifically, an EOAT assembly 270 is shown that may be configurable or configured to cooperate with other elements of the robotic system shown in FIGS. 1A and 1B as well as the arm assemblies 220 shown in FIGS. 1A-3B. The EOAT assemblies 270 of the present disclosure can include, for example, a vertical assembly 210 and an arm assembly 220, to enable the holding, lifting, securing, grasping, managing, moving, or the like, of one or more objects (shown by way of example in FIG. 4C at 50).

In some examples, the EOAT assembly 270 can include a tool base subassembly 270, a first mechanized tool subassembly 280, and a second mechanized tool subassembly 290. The EOAT assembly 270 may also include a force assembly 262, which is shown as being housed within the tool base subassembly 272, though other locations can also be used, depending on the force being measured. The force assembly 262 can be configurable or configured to measure, detect, determine, assess, analyze, estimate, or the like, a force applied by and/or onto one or more elements of the EOAT assembly 270. For example, the force assembly 262 may be configurable or configured to measure, detect, determine, assess, analyze, estimate, or the like, a force applied by and/or onto one or more elements of the first mechanized tool subassembly 280. Alternatively or in addition, the force assembly 262 may be configurable or configured to measure, detect, determine, assess, analyze, estimate, or the like, a force applied by and/or onto one or more elements of the second mechanized tool subassembly 290. Alternatively or in addition, the force assembly 262 may be configurable or configured to measure, detect, determine, assess, analyze, estimate, or the like, a force applied by and/or onto one or more elements of the tool base subassembly 272. Alternatively or in addition, the force assembly 262 may be configurable or configured to measure, detect, determine, assess, analyze, estimate, or the like, the weight and/or one or more dimensions of one or more objects 50 being managed. It is to be understood that the force assembly 262 may also be provided and/or be a part of one or more other elements of the robotic system 100, including the arm assembly 220, the vertical assembly 210, and/or the support body 10, without departing from the teachings of the present disclosure. In further detail, the tool base subassembly 272 may be securable or secured to the second end 260b of the distal joint 260. Once secured, the proximal joint driving system and distal joint driving system (both shown in FIG. 3A) of the arm assembly 220 are then configurable or configured to move the EOAT assembly in Directions C and/or D, respectively. Furthermore, the vertical motion subsystem 217 and/or the support rotary subsystem 211 of the vertical assembly 210 are then configurable or configured to move the arm assembly 220 in Directions A and/or B, respectively, once the tool base subassembly 272 is secured to the second end 260b of the distal joint 260.

Tool Base Subassemblies

In further detail regarding the tool base subassemblies 272, and as illustrated in at least FIG. 4A, the tool base subassembly 272 may be formed as an elongated body with a first end 272a, a second end 272b, and a center region between the first end 272a and the second end 272b. Horizontal Axis F (see at least FIGS. 3 and 4A) is formed through the elongated body of the tool base subassembly 272 and may be configurable or configured to cooperate with other elements of the robotic system 100 (shown in FIGS. 1A-1B), including the first mechanized tool subassembly 280, the second mechanized tool subassembly 290, the vertical assembly 210, the arm assembly 220, and the support body 10, to enable the holding, lifting, securing, grasping, managing, moving, or the like, of one or more objects. In some examples, the tool base subassembly 272 can be formed as a substantially planar rectangle with substantially flat walls/surfaces. However, the tool base subassembly 272 may also be formed as a non-planar rectangle and/or without substantially flat wall(s)/surface(s) without departing from the teachings of the present disclosure. In further detail, the tool base subassembly 272 may include a first subassembly member connector 274, a second subassembly member connector 276, a first horizontal motion subsystem 278, and a second horizontal motion subsystem 279. The tool base subassembly 272 is securable or secured to the second end 260b of the distal joint 260. Once secured, the proximal joint driving system (not shown) and/or distal joint driving system (not shown) of the arm assembly 220 are then configurable or configured to move the EOAT assembly in Directions C and/or D, respectively. Furthermore, the vertical motion subsystem 217 and/or the support rotary subsystem 211 of the vertical assembly 210 are then configurable or configured to move the arm assembly 220 in Directions A and/or B, respectively, once the tool base subassembly 272 is secured to the second end 260b of the distal joint 260.

Subassembly Member Connectors

In some examples, the tool base subassembly 272 can include one or more first subassembly member connectors 274 and one or more second subassembly member connectors 276. For example, the first subassembly member connector 274 may be configurable or configured to secure, at one end, to a portion of the elongated body of the tool base subassembly 272. The first subassembly member connector 274 may also be configurable or configured to secure, at another end, to the first mechanized tool subassembly 280. In operation, the first subassembly member connector 274 may be configurable or configured to be driven by the first horizontal motion subsystem 278 to selectively move the first mechanized tool subassembly 280 between the first end 272a of the tool base subassembly 272 and a center region of the tool base subassembly 272, e.g., from the first end 272a to a center point or near a center point of the tool base subassembly 272. In such operation, the second subassembly member connector 276 is also configurable or configured to be driven by the second horizontal motion subsystem 279 to selectively move the second mechanized tool subassembly 290 between the second end 272b of the tool base subassembly 272 and a center region of the tool base subassembly 272 so as to cooperate with the first subassembly member connector 274 (and the first mechanized tool subassembly 280) in “sandwiching” an object 50 (placed in the pick-up location, as described in the present disclosure) to hold, lift, secure, grasp, manage, move, or the like, the object 50 (with controlled force, as managed by the force assembly 262, so as to ensure the object 50 is not damaged or “crushed”). This can be carried out by partially closing a gap between the first and second mechanized tool subassemblies 280 and 290. Such examples may be useful and/or preferred in situations where the object 50 is positioned equidistant or nearly equidistant to the first mechanized tool subassembly 280 and the second mechanized tool subassembly 290 (and/or in situations where the object 50 can be moved to a center position by the first mechanized tool subassembly 280 and/or the second mechanized tool subassembly 290).

In some embodiments, the first subassembly member connector 274 may be configurable or configured to be driven by the first horizontal motion subsystem 278 to selectively move the first mechanized tool subassembly 280 between the first end 272a of the tool base subassembly 272 and the second end 272b of the tool base subassembly 272. In such operation, the second subassembly member connector 276 may be configurable or configured to either remain stationary (at the second end 272b) or be driven by the second horizontal motion subsystem 279 to selectively move the second mechanized tool subassembly 290 slightly, e.g., while still remaining in or around the second end 272b, so as to cooperate with the first subassembly member connector 274 (and the first mechanized tool subassembly 280) in “sandwiching” an object 50, e.g., placed in the pick-up location, to hold, lift, secure, grasp, manage, move, or the like, the object 50 (with controlled force, as managed by the force assembly 262, so as to ensure the object 50 is not damaged or “crushed”). This can be carried out by partially closing a gap between the first and second mechanized tool subassemblies 280 and 290. Such examples may be useful in situations where the object 50 is positioned closer to the second mechanized tool subassembly 290. The movements of the first subassembly member connector 274 described above and in the present disclosure may be actuated in one or more of a plurality of ways. For example, as illustrated in at least FIG. 4A, the first subassembly member connector 274 may be driven by the first horizontal motion subsystem 278 to move between the first end 272a and a center region of the tool base subassembly 272 (or between the first end 272a and the second end 272b) via one or more guiderails, or the like. It is to be understood that movements of the first subassembly member connector 274 may be performed via one or more other subsystems, devices, mechanism, or ways without departing from the teachings of the present disclosure.

The second subassembly member connector 277 of the tool base subassembly 272 may also include one or more second subassembly member connectors 276. The second subassembly member connector 276 may be configurable or configured to secure, at one end, to a portion of the elongated body of the tool base subassembly 272. The second subassembly member connector 276 is also configurable or configured to secure, at another end of the second mechanized tool subassembly 290. In operation, the second subassembly member connector 276 can be configurable or configured to be driven by the second horizontal motion subsystem 279 to selectively move the second mechanized tool subassembly 290 between the second end 272b of the tool base subassembly 272 and a center region of the tool base subassembly 272, e.g., from the second end 272b to a center point or near a center point of the tool base subassembly 272. In such operation, the first subassembly member connector 274 may also be configurable or configured to be driven by the first horizontal motion subsystem 278 to selectively move the first mechanized tool subassembly 280 between the first end 272a of the tool base subassembly 272 and a center region of the tool base subassembly 272 so as to cooperate with the second subassembly member connector 276 (and the second mechanized tool subassembly 290) in “sandwiching” an object 50, e.g., placed in the pick-up location, to hold, lift, secure, grasp, manage, move, or the like, the object 50 (with controlled force, as managed by the force assembly 262, so as to ensure the object 50 is not damaged or “crushed”). This can be carried out by partially closing a gap between the first and second mechanized tool subassemblies 280 and 290. Such examples may be useful in situations where the object 50 is positioned equidistant or nearly equidistant to the first mechanized tool subassembly 280 and the second mechanized tool subassembly 290 (and/or in situations where the object 50 can be moved to a center position by the first mechanized tool subassembly 280 and/or the second mechanized tool subassembly 290). In further detail, in some examples, the second subassembly member connector 276 may be configurable or configured to be driven by the second horizontal motion subsystem 279 to selectively move the second mechanized tool subassembly 290 between the second end 272b of the tool base subassembly 272 and the first end 272a of the tool base subassembly 272. In such operation, the first subassembly member connector 274 may be configurable or configured to either remain stationary (at the first end 272a) or be driven by the first horizontal motion subsystem 278 to selectively move the first mechanized tool subassembly 280 slightly, e.g., while still remaining in or around the first end 272a, so as to cooperate with the second subassembly member connector 276 (and the second mechanized tool subassembly 290) in “sandwiching” an object 50 (placed in the pick-up location, as described in the present disclosure) to hold, lift, secure, grasp, manage, move, or the like, the object 50 (with controlled force, as managed by the force assembly 262, so as to ensure the object 50 is not damaged or “crushed”). This can be carried out by partially closing a gap between the first and second mechanized tool subassemblies 280 and 290. Such examples may be useful and/or preferred in situations where the object 50 is positioned closer to the second mechanized tool subassembly 290. The movements of the second subassembly member connector 276 described above and in the present disclosure may be actuated in one or more of a plurality of ways. For example, as illustrated in at least FIG. 4A, the second subassembly member connector 276 may be driven by the second horizontal motion subsystem 279 to move between the second end 272b and a center region of the tool base subassembly 272 (or between the first end 272a and the second end 272b) via one or more guiderails, or the like. It is to be understood that movements of the second subassembly member connector 276 may be performed via one or more other subsystems, devices, mechanism, or ways without departing from the teachings of the present disclosure.

Horizontal Motion Subsystems

Regarding the horizontal motion subsystems, there may be a first horizontal motion subsystem 278 and a second horizontal motion subsystem 279 associated with movement of one or both of the mechanized tool subassemblies 280 and 290 along the tool base subassembly 272 of the EOAT Assembly 270. In further detail regarding the first horizontal motion subsystems 278, this subsystem may include any subsystem, device, mechanism, motor, or the like that is configurable or configured to selectively move the first subassembly member connector 274 (and the first mechanized tool subassembly 280) in Direction E (see FIG. 3B) along the horizontal Axis F between first end 272a and the second end 272b of the tool base subassembly 272. For example, the first horizontal motion subsystem may include a motor assembly configurable or configured to drive the first subassembly member connector 274 to selectively move between the first end 272a and the second end 272b of the tool base subassembly 272 so as to position the first mechanized tool subassembly 280 to be at a precise horizontal position, e.g., to grab an object 50 in cooperation with the second mechanized tool subassembly 290. The first horizontal motion subsystem 278 may be housed (as shown) or provided, in part or in whole, in any location within the robotic system 100 (shown in FIGS. 1A-1B). For example, the first horizontal motion subsystem may be housed or provided, in part or in whole, in the EOAT assembly 270. As another example, the first horizontal motion subsystem may be housed or provided, in part or in whole, in the arm assembly 220. As another example, the first horizontal motion subsystem may be housed or provided, in part or in whole, in the vertical assembly 210. As another example, the first horizontal motion subsystem may be housed or provided, in part or in whole, in the support body 10.

In further detail, the EOAT assembly 270 may include one or more second horizontal motion subsystems 279. The second horizontal motion subsystem 279 may include any subsystem, device, mechanism, motor, or the like, configurable or configured to selectively move the second subassembly member connector 276 (and the second mechanized tool subassembly 290) in Direction F (see FIG. 3B) along the horizontal Axis F between the first end 272a and the second end 272b of the tool base subassembly 272. For example, the second horizontal motion subsystem may include a motor assembly configurable or configured to drive the second subassembly member connector 276 to selectively move between the first end 272a and the second end 272b of the tool base subassembly 272 so as to position the second mechanized tool subassembly 290 to be at a precise horizontal position, e.g., to grab an object 50 in cooperation with the first mechanized tool subassembly 280. The second horizontal motion subsystem 279 may likewise be housed (as shown) or provided, in part or in whole, in any location within the robotic system 100 (shown in FIGS. 1A-1B). For example, the second horizontal motion subsystem may be housed or provided, in part or in whole, in the EOAT assembly 270. As another example, the second horizontal motion subsystem may be housed or provided, in part or in whole, in the arm assembly 220. As another example, the second horizontal motion subsystem may be housed or provided, in part or in whole, in the vertical assembly 210. As another example, the second horizontal motion subsystem may be housed or provided, in part or in whole, in the support body 10.

Mechanized Tool Subassemblies

Regarding the mechanized tool subassemblies, there may be a first mechanized tool subassembly 280 and a second tool subassembly, each movably positioned and attached to a tool base subassembly 272 of the EOAT Assembly 270. More specifically, as illustrated in FIGS. 1A-3B, and in greater detail in FIGS. 4A-4K, an example of the EOAT assembly 270 includes a first mechanized tool subassembly 280 and a second mechanized tool subassembly 290. The first mechanized tool subassembly 280 may be formed with a first elongated body 281 with a first end 281a, a second end 281b, and a center region between the first end 281a and the second end 281b. Horizontal Axis G (see at least FIGS. 3B and 4A) is formed through the elongated body 281 of the first mechanized tool subassembly 280 between the first end 281a and the second end 281b. In operation, the first mechanized tool subassembly 280 is configurable or configured to cooperate with other elements of the robotic system 100, including the tool base subassembly 272, the second mechanized tool subassembly 290, the vertical assembly 210, the arm assembly 220, and the support body 10, to enable the holding, lifting, securing, grasping, managing, moving, or the like, of one or more objects 50. In examples, the first mechanized tool subassembly 280 is arranged in such a way that its own central Axis G is orthogonal to Axis F of the tool base subassembly 272. However, it is to be understood that the first mechanized tool subassembly 280 may also be arranged in such a way that its own central Axis G is not orthogonal to Axis F of the tool base subassembly 272 without departing from the teachings of the present disclosure. Furthermore, in examples, the first mechanized tool subassembly 280 is formed as a substantially planar rectangle with substantially flat walls/surfaces. However, it is to be understood that the first mechanized tool subassembly 280 may also be formed as a non-planar rectangle and/or without substantially flat wall(s)/surface(s) without departing from the teachings of the present disclosure. In some examples, the first mechanized tool subassembly 280 may include a first holding member joint 284 (or plurality of first holding member joints 284), a first tool rotary subsystem 283, a first holding member 282, a first opening 285, a first lifting member 286, a first lifting member rotary subsystem 287, and a first lifting assist member 288. The first mechanized tool subassembly 280 may be securable or secured to the tool base subassembly 272 via the first subassembly member connector 274. Once secured, the first horizontal motion subsystem of the tool base subassembly 272 is then configurable or configured to move the first mechanized tool subassembly 280 in Direction E (as illustrated in FIG. 3B).

As also illustrated in at least FIGS. 3B, 4A, and 4C, the example of the EOAT assembly 270 includes a second mechanized tool subassembly 290. As illustrated in at least FIGS. 3B and 4A, the second mechanized tool subassembly 290 may be formed as a second elongated body 291 with a first end 291a, a second end 291b, and a region between the first end 291a and the second end 291b. A horizontal Axis H may be formed through the second elongated body 291 of the second mechanized tool subassembly 290 between the first end 291a and the second end 291b. In operation, the second mechanized tool subassembly 290 may be configurable or configured to cooperate with other elements of the robotic system 100 (see FIG. 1A), including the tool base subassembly 272, the first mechanized tool subassembly 280, the vertical assembly 210, the arm assembly 220, the support body 10, etc., to enable the holding, lifting, securing, grasping, managing, moving, or the like, of one or more objects 50. In some examples, the second mechanized tool subassembly 290 may be arranged in such a way that its own central Axis H is orthogonal to Axis F of the tool base subassembly 272. However, it is to be understood that the second mechanized tool subassembly 290 may also be arranged in such a way that its own central Axis H is not orthogonal to Axis F of the tool base subassembly 272 without departing from the teachings of the present disclosure. Furthermore, in examples, the second mechanized tool subassembly 290 is arranged in such a way that its own central Axis H is parallel to central Axis G of the first mechanized tool subassembly 280. However, it is to be understood that the second assembly 290 may also be arranged in such a way that its own central Axis H is not parallel to Axis G of the first mechanized tool subassembly 280 without departing from the teachings of the present disclosure. Furthermore, in examples, the second mechanized tool subassembly 290 is formed as a substantially planar rectangle with substantially flat walls/surfaces. However, it is to be understood that the second mechanized tool subassembly 290 may also be formed as a non-planar rectangle and/or without substantially flat wall(s)/surface(s) without departing from the teachings of the present disclosure.

The second mechanized tool subassembly 290 may include a second holding member joint, e.g., second holding member joint 294, a second tool rotary subsystem 293 (not shown, but shown in FIG. 7), a second holding member, e.g., second holding member 292, a second opening, e.g., second opening 295, a second lifting member, e.g., second lifting member 296, a second lifting member rotary subsystem 297, and a second lifting assist member, e.g., second lifting assist member 298. The second mechanized tool subassembly 290 is securable or secured to the tool base subassembly 272 via the second subassembly member connector 276. Once secured, the second horizontal motion subsystem of the tool base subassembly 272 is then configurable or configured to move the second mechanized tool subassembly 290 in Direction F (as illustrated in FIG. 3B).

Holding Members

Regarding the holding members, there may be a first holding member 282 and a second holding member 292, each positioned on their respective mechanized tool subassembly. Referring again more specifically to FIGS. 4A-4K, an example of the first mechanized tool subassembly 280 is shown, and includes one or more first holding members 282. The first holding members 282 may be formed to interact with the first elongated body 281. The first holding members 282 may include and/or be formed in one or more of various shapes, e.g., rectangular, triangular, etc., so long as the first holding member 282 is formed in such a way as to enable appropriate contact and lifting of objects 50, which typically occurs from beneath the object 50 as shown in FIG. 4C. In some embodiments, a contact surface of each of the first holding members 282 may include protrusions, patterns, non-slip coverings, etc., and/or be treated in such a way as to assist in gripping an object 50 and/or preventing an object 50 from moving or slipping relative to the contact surface of the first holding member 282. Notably, in the example, shown, there are four (4) first holding members 282, but it is to be understood that the first mechanized tool subassembly 280 may include more or less than four first holding members 282 without departing from the teachings of the present disclosure. For example, the first mechanized tool subassembly 280 may include one (or more) first holding member 282 formed in the shape of an elongated triangle 282, as shown, or by any other shape, e.g., rectangle, with one of its elongated sides typically extending parallel or near parallel to Axis K. Other arrangements can also be used, depending on the object 50 designed for pick up.

The first holding members 282 may be configurable or configured to secure to a first end of the first holding member joint 284. Once secured, the first holding member 282 is selectively movable or rotatable relative to horizontal Axis K and also selectively positionable to be directed in any direction around horizontal Axis K, e.g., when the first tool rotary subsystem 283 drives the first holding member joint(s) 284 to move or rotate the first holding members 282. In examples where the first mechanized tool subassembly 280 includes more than one first holding member 282, e.g., four first holding members 282 as illustrated in the FIGS., the individual first holding members 282 may be independently controllable to move or rotate relative to horizontal Axis K. In other examples where the first mechanized tool subassembly 280 includes more than one first holding member 282, some or all of the first holding members 282 may be collectively controllable to move or rotate together relative to horizontal Axis K. For example, the first holding member joints 284 may be connected collective to a common vertical translation bar 289 to be collectively actuated.

In operation, the first holding members 282 may be configurable or configured to move or rotate between a first horizontal position or engaged position as illustrated in at least FIGS. 4A, 4C, 4D-G, and a second vertical position or disengaged position as illustrated in at least FIGS. 4B and FIGS. 4H-J. The engaged position indicates that the holding members 282 are positioned to support the object to be lifted. The disengaged position indicates that the holding members 282 are positioned for alignment and placing the object with a gap 299 between the mechanized tool subassemblies 280 and 290 without interfering or damaging the object. For example, when it is desired to lift or pick up an object 50 positioned from a pick-up location, e.g., the conveyer belt 12 shown in at least FIG. 1A, the first holding members 282 may first be positioned or actuated in their second vertical position (or disengaged position) while the EOAT assembly 270 is being properly positioned above the conveyer belt. Once the EOAT assembly 270 is properly positioned above the conveyer belt, the first holding members 282 may then be transitioned to the first horizontal position. In other examples, the first holding members could also be transitioned from the first horizontal position to the second horizontal position after the first elongated body 281 and the second elongated body are positioned about the object 50, such as from the conveyer belt. As shown in FIGS. 4D, 4F, and 4J, the conveyer belt 12 may be supported by a conveyer belt support 12a with conveyer belt spacing 12b configured to accommodate the rotation of the first holding members back and forth between their first horizontal positon and their second horizontal position.

The first elongated body 281 of the first mechanized tool subassembly 280 and the second elongated body 291 of the second mechanized tool subassembly 290 may then be driven together towards the object 50 via a first horizontal motion subsystem 278 and a second horizontal motion subsystem 279 to “sandwich” the object 50 between the first elongated body 281 and the second elongated body 291. To commence the lifting of the object 50, the first holding members 282 will then be brought directly under the object 50 so as to enable the lifting of the object 50 from the conveyer belt 12. Lifting can occur via the first holding members 282 and the vertical motion subsystem of the vertical assembly 210, and may also include the cooperation of other elements of the robotic system, including the first lifting member 286 and/or the first lifting assist member 288. In some examples, one or more first holding members 282, the first holding member joints 284, and/or the first tool rotary subsystem 283 may be in communication with the force assembly 262 so as to assist in measuring, detecting, determining, assessing, analyzing, estimating, or the like, the force applied by and/or onto an object 50, the weight of object 50, and/or one or more dimensions of the object 50.

As illustrated in at least FIGS. 4A, 4C, 4E, and 4H, an example of the second mechanized tool subassembly 290 includes one or more second holding members 292. The second holding member 292 may include and/or be formed as an elongated body. Alternatively or in addition, one or more of the second holding members 292 may include and/or be formed in one or more other shapes, e.g., rectangular, triangular, etc., so long as the second holding member 292 is formed in such a way as to enable appropriate contact and lifting of objects 50, e.g., from underneath the object 50. In some embodiments, a contact surface of each of the second holding members 292 may include protrusions, patterns, non-slip coverings, etc., and/or be treated in such a way as to assist in gripping object 50 and prevent object 50 from moving or slipping relative to the contact surface of the second holding member 292. Although the present disclosure may illustrate the second mechanized tool subassembly 290 as including 4 second holding members 292, it is to be understood that the second mechanized tool subassembly 290 may include more or less than 4 second holding members 292 without departing from the teachings of the present disclosure. For example, the second mechanized tool subassembly 290 may include one (or more) second holding member 292 formed in the shape of a rectangle, e.g., with its longer side extending parallel or near parallel to Axis K, or the like.

The second holding member 292 may be configurable or configured to secure to a first end of the second holding member joint 294. Once secured, the second holding member 292 is selectively movable or rotatable relative to horizontal Axis N and also selectively positionable to be directed in any direction around horizontal Axis N, e.g., when the second tool rotary subsystem 293 drives the second holding member joint(s) 294 to move or rotate the second holding members 292. In examples where the second mechanized tool subassembly 290 includes more than one second holding member 292, e.g., four second holding members 292, as illustrated in the Figures, each second holding member 292 may be individually and/or independently controllable to move or rotate relative to horizontal Axis N. In some examples where the second mechanized tool subassembly 290 includes more than one second holding member 292, e.g., four second holding members 292, some or all of the second holding members 292 may be collectively controllable to move or rotate together relative to horizontal Axis N.

In operation, the second holding member(s) 292 may be configurable or configured to move or rotate between a first horizontal position or engaged position as illustrated in at least FIGS. 4A, 4C, and 4E and a second vertical position or disengaged position as illustrated in at least FIG. 4H. For example, when it is desired to lift or pick up an object 50 positioned on the conveyer belt 12, e.g., in the pick-up location, the second holding members 292 will first be positioned or actuated in the second vertical position disengaged position while the EOAT assembly 270 is being properly positioned above the conveyer belt 12 (see the second vertical positions of the second holding members 282 in FIG. 4H). Once the EOAT assembly 270 is properly positioned above the conveyer belt 12, the second holding members 292 will then be transitioned to the first horizontal position (see the first horizontal positions of the second holding members 292 in FIGS. 4A, 4C, and 4E). The second elongated body 291 of the second mechanized tool subassembly 290 and first elongated body 281 of the first mechanized tool subassembly 280 will then be driven towards the object 50 (via the second horizontal motion subsystem and first horizontal motion subsystem, as described in the present disclosure) to “sandwich” the object 50. To commence the lifting of the object 50, the second holding members 292 will then be brought directly under the object 50 so as to enable the lifting of the object 50 from the conveyer belt 12 (via the second holding members 292 and the vertical motion subsystem of the vertical assembly 210; and may also include the cooperation of other elements of the robotic system 100, including the second lifting member 296 and/or the second lifting assist member 298). In some examples, one or more second holding members 292, the second holding member joints 294, and/or the second tool rotary subsystem 293 are in communication with the force assembly 262 so as to assist in measuring, detecting, determining, assessing, analyzing, estimating, or the like, a force applied by and/or onto an object 50, a weight of object 50, and/or one or more dimensions of object 50.

Holding Member Joints

Regarding the holding member joints, there may be a first holding member joint 284 and a second holding member joint 294, each positioned on their respective mechanized tool subassembly. As illustrated in at least FIGS. 4A-K, an example of the first mechanized tool subassembly 280 includes one or more first holding member joints 284. The first holding member joint 284 may include a first end that is secured to the first elongated body 281 of the first mechanized tool subassembly 280 and a second end that is secured to the first holding member 282. The first holding member joints 284 include a region that allows for actuation, e.g., a hinge, pivot, or the like. Thus, the second end of the first holding member joint 284 may pivot or rotate relative to the first end of the first holding member joint 284, allowing the first end of the first holding member joint 284 to pivot or rotate relative to the second end of the first holding member joint 284. As illustrated in at least FIGS. 3A and 4A, the first holding member joint 284 includes horizontal Axis K formed through the central portion of the first holding member joint 284. In this regard, the first holding member joint 284 is configurable or configured in such a way as to allow the second end of the first holding member joint 284 to pivot or rotate relative to horizontal Axis K. In an example, such pivoting or rotation of the second end of the first holding member joint 284 (and the first holding member 282) is selectively controlled and driven by the first tool rotary subsystem 283. In some examples, the first holding member joint 284 is arranged in such a way that its own central Axis K is parallel to central Axis G of the first mechanized tool subassembly 280. However, it is to be understood that the first holding member joint 284 may also be arranged in such a way that its own central Axis K is not parallel to central Axis G of the first mechanized tool subassembly 280 without departing from the teachings of the present disclosure. In some examples, the first end of the first holding member joint 284 may be secured to or formed together with the first elongated body 281 of the first mechanized tool subassembly 280. Furthermore, the second end of the first holding member joint 284 may be secured to or formed together with the first holding member 282.

As illustrated in at least FIGS. 4A, 4C, 4E, and 4H, an example of the second mechanized tool subassembly 290 includes one or more second holding member joints 294. The second holding member joint 294 may include a first end (secured to the second elongated body 291 of the second mechanized tool subassembly 290), a second end (secured to the second holding member 292), and a central region that allows for actuation, e.g., a hinge, pivot, or the like, allowing the second end of the second holding member joint 294 to pivot or rotate relative to the first end of the second holding member joint 294 (and allow the first end of the second holding member joint 294 to pivot or rotate relative to the second end of the second holding member joint 294). Furthermore, in this example, the second holding member joint 294 includes horizontal Axis N formed through the central portion of the second holding member joint 294. In this regard, the second holding member joint 294 is configurable or configured in such a way as to allow the second end of the second holding member joint 294 to pivot or rotate relative to horizontal Axis N. Such pivoting or rotation of the second end of the second holding member joint 294 (and the second holding member 292) may be selectively controlled and driven by the second tool rotary subsystem 293. In some examples, the second holding member joint 294 is arranged in such a way that its own central Axis N is parallel to central Axis H of the second mechanized tool subassembly 290. However, it is to be understood that the second holding member joint 294 may also be arranged in such a way that its own central Axis N is not parallel to central Axis H of the second mechanized tool subassembly 290 without departing from the teachings of the present disclosure. In further detail, the first end of the second holding member joint 294 may be secured to or formed together with the second elongated body 291 of the second mechanized tool subassembly 290. Furthermore, the second end of the second holding member joint 294 may be secured to or formed together with the second holding member 292.

Rotary Subsystems

Regarding the rotary subsystems, there may be a first tool rotary subsystem 283 and a second rotary subsystem 293, each positioned on their respective mechanized tool subassembly. Thus, the first mechanized tool subassembly 280 can include one or more first tool rotary subsystems 283. The first tool rotary subsystem 283 may be any subsystem, device, mechanism, motor, or the like, configurable or configured to selectively rotate the first holding member 282 around or relative to the Axis K (see at least FIGS. 3A and 4A). For example, the first tool rotary subsystem 283 may be or include a motor assembly configurable or configured to drive the first holding member 282 to selectively rotate around or relative to the Axis K so as to position the first holding member 282 to be precisely directed in any one of a plurality of directions around the Axis K. In some examples, the first tool rotary subsystem 283 may selectively rotate the first holding member 282 to transition between a horizontal position or engaged position as illustrated in at least FIGS. 4A, 4C, 4E, 4F, and 4G, which represents a position in which an object 50 is being held or lifted, and a vertical position or disengaged position as illustrated in at least FIGS. 4B, 4H, 4J, and 4K. The first tool rotary subsystem 283 may be housed or provided, in part or in whole, in any location within the robotic system 100 (see FIG. 1A), but in the example shown at FIG. 4A, is positioned within the EOAT assembly 270. As another example, the first tool rotary subsystem 283 may be housed or provided, in part or in whole, in the arm assembly 220. As another example, the first tool rotary subsystem 283 may be housed or provided, in part or in whole, in the vertical assembly 210. As another example, the first tool rotary subsystem 283 may be housed or provided, in part or in whole, in the support body 10.

A second mechanized tool subassembly 290 of the EOAT assembly 270 may include one or more second tool rotary subsystem 293. The second tool rotary subsystem 293 (not shown as being obscured, but shown in FIG. 7) may be any subsystem, device, mechanism, motor, or the like, configurable or configured to selectively rotate the second holding member 292 around or relative to the Axis N (see at least FIG. 4A). For example, the second tool rotary subsystem 293 may be or include a motor assembly configurable or configured to drive the second holding member 292 to selectively rotate around or relative to the Axis N so as to position the second holding member 292 to be precisely directed in any one of a plurality of directions around the Axis N. In preferred examples, the second tool rotary subsystem 293 selectively rotates the second holding member 292 to transition between a horizontal position or engaged position as illustrated in at least FIGS. 4A, 4C, and 4E, which represents a position in which an object 50 is being held or lifted, and a vertical position or disengaged position as illustrated in at least FIG. 4H. The second tool rotary subsystem 293 may be housed or provided, in part or in whole, in any location within the robotic system 100. For example, the second tool rotary subsystem 293 may be housed or provided, in part or in whole, in the EOAT assembly 220. As another example, the second tool rotary subsystem 293 may be housed or provided, in part or in whole, in the arm assembly 220. As another example, the second tool rotary subsystem 293 may be housed or provided, in part or in whole, in the vertical assembly 210. As another example, the second tool rotary subsystem 293 may be housed or provided, in part or in whole, in the support body 10.

Openings

Regarding the openings, there may be a first opening 285 and a second opening 295, each positioned on their respective mechanized tool subassembly. The first mechanized tool subassembly 280 includes one or more first openings 285 formed in such a shape, size, and dimension so as to enable at least a portion of the first lifting member 286 and/or at least a portion of the first lifting assist member 288 to at least partially move or pass therethrough, which enables the first lifting member 286 and/or the first lifting assist member 288 to lift, pick up, and/or otherwise move the object 50 from its resting surface, e.g., a surface of the conveyer belt 12, a surface of a baggage trolley, the ground, etc. In additional detail, the second mechanized tool subassembly 290 may include one or more second openings 295. The second opening 295 may also be formed in such shape, size and dimension so as to enable at least a portion of the second lifting member 296 and/or at least a portion of the second lifting assist member 298 to move or pass through, which enables the second lifting member 296 and/or the second lifting assist member 298 to lift, pick up, and/or otherwise move the object 50 from its resting surface, e.g., a surface of the conveyer belt 12, a surface of a baggage trolley, the ground, etc.

Lifting Members

Regarding the lifting members, there may be a first lifting member 286 and a second lifting member 296, each positioned on their respective mechanized tool subassembly. The first lifting member(s) 286 may include and/or be formed in any shape or form, but in this example are in the shape of a cylinder 286. Alternatively or in addition, the first lifting member 286 may configured as a conveyer, so long as the first lifting member 286 is formed in such a way as to enable appropriate contact and lifting of objects from a side surface of the objects. In some examples, at least a portion of a perimeter contact surface of each first lifting members 286 may include protrusions, patterns, non-slip coverings, etc., and/or be treated in such a way as to assist in gripping object 50 and prevent object 50 from moving relative to the contact surface of the first lifting member 286. The present disclosure illustrates the first mechanized tool subassembly 280 as including one (1) first lifting member 286, but it is to be understood that the first mechanized tool subassembly 280 may include more or less than one first lifting member 286 without departing from the teachings of the present disclosure. For example, the first mechanized tool subassembly 280 may include two or more first lifting members 286 arranged in parallel and one above the other. As another example, the first mechanized tool subassembly 280 may include two or more first lifting members 286 arranged in parallel and one next to the other. As another example, the first mechanized tool subassembly 280 may include three or more first lifting members 286 arranged as a combination of the above examples. The lifting member(s) 286 may be configurable or configured to secure to at least a portion of the first elongated body 281 of the first mechanized tool subassembly 280. Once secured, the first lifting member 286 in this example is selectively movable or rotatable relative to its own central Axis J, e.g., when the first lifting member rotary subsystem 287 drives the first lifting member 286. In some examples, the first lifting member 286 is arranged in such a way that its own central Axis J is orthogonal to Axis F of the tool base subassembly 272. However, it is to be understood that the first lifting member 286 may also be arranged in such a way that its own central Axis J is not orthogonal to Axis F of the tool base subassembly 272 without departing from the teachings of the present disclosure.

In operation, the first lifting member(s) 286 may be configurable or configured to move or rotate in such a direction that enables an object 50 (see FIG. 4C), when in contact with the first lifting member 286, either directly or indirectly via the first lifting assist member (obscured from view in FIGS. 4A-4K, but show in FIG. 3B), to be lifted or moved from its resting surface, e.g., the surface of the conveyer belt 12, a surface of a baggage trolley, the ground, etc. In some examples, lifting or moving of the object 50 may be performed in cooperation with one or more other elements of the EOAT assembly 270, e.g., in cooperation with the second lifting member 296, the second elongated body 291 of the second EOAT assembly 290, the first holding member 282, and/or the second holding member 292, etc. For example, when it is desired to lift or pick up an object 50 positioned on a resting surface, e.g., surface of a baggage trolley or the ground, the EOAT assembly 270 may be positioned so as to surround the object 50 between the tool base subassembly 272, the first mechanized tool subassembly 280, and the second mechanized tool subassembly 290. Once the EOAT assembly 270 is properly positioned, the first elongated body 281 of the first mechanized tool subassembly 280 and the second elongated body 291 of the second mechanized tool subassembly 290 will then be driven towards the object 50 via the first horizontal motion subsystem and the second horizontal motion subsystem to “sandwich” the object 50. In this regard, a surface of the first lifting member 286 (or in examples in which the first mechanized tool subassembly 280 includes the first lifting assist member 288, a surface of the first lifting assist member 288) contacts with at least a portion of a side wall of the object 50. In examples in which the second mechanized tool subassembly 290 includes the second lifting member 296, a surface of the second lifting member 296 (or in examples in which the second mechanized tool subassembly 290 includes the second lifting assist member 298, a surface of the second lifting assist member 298) also contacts with at least a portion of an opposite side wall of the object 50. To commence the lifting of the object 50, the first lifting member 286 is driven to rotate so as to lift the object 50 slightly from its resting surface. In examples in which the second mechanized tool subassembly 290 includes the second lifting member 296, the second lifting member 296 may also be driven to rotate so as to lift the object 50 (from the opposite side wall of object 50) slightly from its resting surface. Thereafter, the first holding members 282 (and/or second holding members 292) may (or may not) assist in lifting the object 50. In some examples, one or more first lifting members 286 and/or the first lifting member rotary subsystem are in communication with the force assembly 262 so as to assist in measuring, detecting, determining, assessing, analyzing, estimating, or the like, a force applied by and/or onto an object 50, a weight of object 50, and/or one or more dimensions of object 50.

As illustrated in at least FIGS. 3B, 4A, 4C, 4E, and 4H, an example of the second mechanized tool subassembly 290 is shown and may include one or more second lifting members 296. The second lifting members 296 may include and/or be formed in the shape of a cylinder 296, as shown, or may alternatively or additionally be shaped or formed otherwise, e.g., spherical shape, conveyer belt, etc., so long as the second lifting member 296 is formed in such a way as to enable appropriate contact and lifting of objects 50, e.g., from a side of the object 50. In some examples, at least a portion of a perimeter contact surface of the second lifting members 296 may include protrusions, patterns, non-slip coverings, etc., and/or be treated in such a way as to assist in gripping object 50 and prevent object 50 from moving relative to the contact surface of the second lifting member 296. Although the present disclosure may illustrate the second mechanized tool subassembly 290 as including one (1) second lifting member 296, it is to be understood that the second mechanized tool subassembly 290 may include more or less than one second lifting member 296 without departing from the teachings of the present disclosure. For example, the second mechanized tool subassembly 290 may include two or more second lifting members 296 arranged in parallel and one above the other. As another example, the second mechanized tool subassembly 290 may include two or more second lifting members 296 arranged in parallel and one next to the other. As another example, the second mechanized tool subassembly 290 may include three or more second lifting members 296 arranged as a combination of the above examples. The second lifting members 296 may be configurable or configured to secure to at least a portion of the second elongated body 291 of the second mechanized tool subassembly 290. Once secured, the second lifting member 296 is selectively movable or rotatable relative to its own central Axis M, e.g., when the second lifting member rotary subsystem drives the second lifting member 296. In examples, the second lifting member 296 is arranged in such a way that its own central Axis M is orthogonal to Axis F of the tool base subassembly 272. However, it is to be understood that the second lifting member 296 may also be arranged in such a way that its own central Axis M is not orthogonal to Axis F of the tool base subassembly 272 without departing from the teachings of the present disclosure.

In operation, the second lifting member 296 may be configurable or configured to move or rotate in such a direction that enables an object 50, when in contact with the second lifting member 296 (directly or indirectly via the second lifting assist member 298), to be lifted or moved from its resting surface, e.g., the surface of the conveyer belt 12, a surface of a baggage trolley (not shown), the ground, etc. In some examples, such lifting or moving is performed in cooperation with one or more elements of the EOAT assembly 270, e.g., in cooperation with the first lifting member 286, the first elongated body 281 of the first mechanized tool subassembly 280, the first holding member 282, the second holding member 292, etc. For example, when it is desired to lift or pick up an object 50 positioned on a resting surface, e.g., surface of a baggage trolley or the ground, the EOAT assembly 270 is positioned so as to surround the object 50, e.g., between the tool base subassembly 272, the first mechanized tool subassembly 280, and the second mechanized tool subassembly 290. Once the EOAT assembly 270 is properly positioned, the second elongated body 291 of the second mechanized tool subassembly 290 and the first elongated body 281 of the first mechanized tool subassembly 280 will then be driven towards the object 50 (via the second horizontal motion subsystem and first horizontal motion subsystem, as described in the present disclosure) to “sandwich” the object 50. In this regard, a surface of the second lifting member 296 (or in examples in which the second mechanized tool subassembly 290 includes the second lifting assist member 298, a surface of the second lifting assist member 298) contacts with at least a portion of a side wall of the object 50. In examples in which the first mechanized tool subassembly 280 includes the first lifting member 286, a surface of the first lifting member 286 (or in examples in which the first mechanized tool subassembly 280 includes the first lifting assist member 288, a surface of the first lifting assist member 288) also contacts with at least a portion of an opposite side wall of the object 50. To commence the lifting of the object 50, the second lifting member 296 is driven to rotate so as to lift the object 50 slightly from its resting surface. In examples in which the first mechanized tool subassembly 280 includes the first lifting member 286, the first lifting member 286 may also be driven to rotate so as to lift the object 50 (from the opposite side wall of object 50) slightly from its resting surface. Thereafter, the second holding members 292 (and/or first holding members 282) may (or may not) assist in lifting the object 50. In further detail, one or more second lifting members 296 and/or the second lifting member rotary subsystem are in communication with the force assembly 262 so as to assist in measuring, detecting, determining, assessing, analyzing, estimating, or the like, a force applied by and/or onto an object 50, a weight of object 50, and/or one or more dimensions of object 50.

Lifting Member Rotary Subsystems

Regarding the lifting member rotary subsystems, there may be a first lifting member rotary subsystem 287 and a second lifting member rotary subsystem 297 which may be positioned at or near to their respective mechanized tool subassembly. The first mechanized tool subassembly 280 may also include one or more first lifting member rotary subsystems 287. The first lifting member rotary subsystem 287 may be any subsystem, device, mechanism, motor, or the like, configurable or configured to selectively rotate the first lifting member 286 around or relative to the Axis J (see at least FIG. 4A). For example, the first lifting member rotary subsystem may be or include a motor assembly configurable or configured to drive the first lifting member 286 to selectively rotate around or relative to its own central Axis, namely Axis J. The first lifting member rotary subsystem may be housed or provided, in part or in whole, in any location within the robotic system 100. For example, the first lifting member rotary subsystem may be housed or provided, in part or in whole, in the EOAT assembly 220. As another example, the first lifting member rotary subsystem may be housed or provided, in part or in whole, in the arm assembly 220. As another example, the first lifting member rotary subsystem may be housed or provided, in part or in whole, in the vertical assembly 210. As another example, the first lifting member rotary subsystem may be housed or provided, in part or in whole, in the support body 10.

The second mechanized tool subassembly 290 may include one or more second lifting member rotary subsystems 297. The second lifting member rotary subsystem may be any subsystem, device, mechanism, motor, or the like, configurable or configured to selectively rotate the second lifting member 296 around or relative to the Axis M (see at least FIG. 4A). For example, the second lifting member rotary subsystem may be or include a motor assembly configurable or configured to drive the second lifting member 296 to selectively rotate around or relative to its own central Axis, namely Axis M. The second lifting member rotary subsystem may be housed or provided, in part or in whole, in any location within the robotic system 100. For example, the second lifting member rotary subsystem may be housed or provided, in part or in whole, in the EOAT assembly 220. As another example, the second lifting member rotary subsystem may be housed or provided, in part or in whole, in the arm assembly 220. As another example, the second lifting member rotary subsystem may be housed or provided, in part or in whole, in the vertical assembly 210. As another example, the second lifting member rotary subsystem may be housed or provided, in part or in whole, in the support body 10.

Lifting Assist Members

Regarding the lifting assist members, there may be a first lifting assist member 288 and a second lifting assist member 298, each positioned on their respective mechanized tool subassembly. As illustrated in at least FIGS. 3 and 4A, an example of the first mechanized tool subassembly 280 is shown including one or more first lifting assist members 288. The first lifting assist member 288 may include and/or be formed in the shape of a rectangle 288 or any other suitable shape, e.g., square, triangle, oval, circular, parabolic, etc., so long as the first lifting assist member 288 is formed in such a way as to enable appropriate contact and lifting of objects 50, e.g., from a side of the object 50, via cooperation with the first lifting member 286. In some embodiments, at least a portion of a perimeter contact surface of each first lifting assist members 288 may include protrusions, patterns, non-slip coverings, etc., and/or be treated in such a way as to assist in gripping object 50 and preventing object 50 from moving relative to the contact surface of the first lifting assist member 288.

Although the present disclosure may illustrate the first mechanized tool subassembly 280 as including one (1) first lifting assist member 288 (see FIG. 3B), it is to be understood that the first mechanized tool subassembly 280 may include more or less than a single first lifting assist member 288 without departing from the teachings of the present disclosure. For example, the first mechanized tool subassembly 280 may include two or more first lifting assist members 288 for each first lifting member 286, e.g., arranged in a side-by-side manner. As another example, when the first assembly 280 includes two or more first lifting members 286, the first mechanized tool subassembly 280 may include one first lifting assist member 288 for each first lifting member 286. As another example, when the first mechanized tool subassembly 280 includes a plurality of first lifting members 286, a first lifting assist member 288 may not be provided for every first lifting member 286. In further detail, the first lifting member 286 may be configurable or configured to secure to at least a portion of the first elongated body 281 of the first mechanized tool subassembly 280 and/or a portion of the first lifting member 286. Once secured, the first lifting assist member 288 is selectively movable or rotatable in correspondence with the first lifting member 286, e.g., a movement or rotation of the first lifting member 286 will cause a movement or rotation of the first lifting assist member 288.

In operation, the first lifting member(s) 286 and corresponding first lifting assist member(s) 288 may be configurable or configured to move or rotate in such a direction that enables an object 50, when in contact with the first lifting assist member 288, to be lifted or moved from its resting surface, e.g., the surface of the conveyer belt 12, a surface of a baggage trolley (not shown), the ground, etc. In examples, such lifting or moving is performed in cooperation with one or more elements of the EOAT assembly 270, e.g., in cooperation with the second lifting member 296, the second elongated body 291 of the second mechanized tool subassembly 290, the first holding member 282, the second holding member 292, etc. For example, when it is desired to lift or pick up an object 50 positioned on a resting surface, e.g., surface of a baggage trolley or the ground, the EOAT assembly 270 is positioned so as to surround the object 50, e.g., between the tool base subassembly 272, the first mechanized tool subassembly 280, and the second mechanized tool subassembly 290. Once the EOAT assembly 270 is properly positioned, the first elongated body 281 of the first mechanized tool subassembly 280 and the second elongated body 291 of the second mechanized tool subassembly 290 will then be driven towards the object 50 (via the first horizontal motion subsystem and second horizontal motion subsystem, as described in the present disclosure) to “sandwich” the object 50. In this regard, a surface of the first lifting assist member 288 contacts with at least a portion of a side wall of the object 50. In examples in which the second mechanized tool subassembly 290 includes the second lifting member 296, a surface of the second lifting member 296 (or in examples in which the second mechanized tool subassembly 290 includes the second lifting assist member 298, a surface of the second lifting assist member 298) also contacts with at least a portion of an opposite side wall of the object 50. To commence the lifting of the object 50, the first lifting member 286 is driven to rotate so as to move the first lifting assist member 288 and lift the object 50 slightly from its resting surface. In examples in which the second mechanized tool subassembly 290 includes the second lifting member 296, the second lifting member 296 may also be driven to rotate so as to lift the object 50 (from the opposite side wall of object 50) slightly from its resting surface. Thereafter, the first holding members 282 (and/or second holding members 292) may (or may not) assist in lifting the object 50. In some examples, one or more first lifting assist members 288, one or more first lifting members 286, and/or the first lifting member rotary subsystem are in communication with the force assembly 262 so as to assist in measuring, detecting, determining, assessing, analyzing, estimating, or the like, a force applied by and/or onto an object 50, a weight of object 50, and/or one or more dimensions of object 50.

In further detail, also as illustrated in at least FIGS. 3B and 4A, the second mechanized tool subassembly 290 is shown and includes one or more second lifting assist members 298. The second lifting assist member 298 may include and/or be formed in the shape of a rectangle or any other suitable shape, e.g., square, triangular, oval, circular, parabolic, or the like, so long as the second lifting assist member 298 is formed in such a way as to enable appropriate contact and lifting of objects 50, e.g., from a side of the object 50, via cooperation with the second lifting member 296. In some examples, at least a portion of a perimeter contact surface of each second lifting assist members 298 may include protrusions, patterns, non-slip coverings, etc., and/or be treated in such a way as to assist in gripping object 50 and preventing object 50 from moving relative to the contact surface of the second lifting assist member 298.

Although the present disclosure may illustrate the second mechanized tool subassembly 290 as including one (1) second lifting assist member 298, it is to be understood that the second mechanized tool subassembly 290 may include more or less than 1 second lifting assist member 298 without departing from the teachings of the present disclosure. For example, the second mechanized tool subassembly 290 may include two or more second lifting assist members 298 for each second lifting member 296, e.g., arranged in a side-by-side manner. As another example, when the second mechanized tool subassembly 290 includes two or more second lifting members 296, the second mechanized tool subassembly 290 may include one second lifting assist member 298 for each second lifting member 296. As another example, when the second mechanized tool subassembly 290 includes a plurality of second lifting members 296, a second lifting assist member 298 may not be provided for every second lifting member 296. Furthermore, the second lifting member 296 may be configurable or configured to secure to at least a portion of the second elongated body 291 of the second mechanized tool subassembly 290 and/or a portion of the second lifting member 296. Once secured, the second lifting assist member 298 is selectively movable or rotatable in correspondence with the second lifting member 296, e.g., a movement or rotation of the second lifting member 296 will cause a movement or rotation of the second lifting assist member 298.

In operation, the second lifting member 296 and any corresponding second lifting assist members 298 may be configurable or configured to move or rotate in such a direction that enables an object 50, when in contact with the second lifting assist member 298, to be lifted or moved from its resting surface, e.g., the surface of the conveyer belt 12, a surface of a baggage trolley (not shown), the ground, etc. In examples, such lifting or moving is performed in cooperation with one or more elements of the EOAT assembly 270, e.g., in cooperation with the first lifting member 286, the first elongated body 281 of the first mechanized tool subassembly 280, the first holding member 282, the second holding member 292, etc. For example, when it is desired to lift or pick up an object 50 positioned on a resting surface, e.g., surface of a baggage trolley or the ground, the EOAT assembly 270 is positioned so as to surround the object 50, e.g., between the tool base subassembly 272, the first mechanized tool subassembly 280, and the second mechanized tool subassembly 290. Once the EOAT assembly 270 is properly positioned, the first elongated body 281 of the first mechanized tool subassembly 280 and second elongated body 291 of the second mechanized tool subassembly 290 will then be driven towards the object 50 (via the first horizontal motion subsystem and the second horizontal motion subsystem, as described in the present disclosure) to “sandwich” the object 50. In this regard, a surface of the second lifting assist member 298 contacts with at least a portion of a side wall of the object 50. In examples in which the first mechanized tool subassembly 280 includes the first lifting member 286, a surface of the first lifting member 286 (or in examples in which the first mechanized tool subassembly 280 includes the first lifting assist member 288, a surface of the first lifting assist member 288) also contacts with at least a portion of an opposite side wall of the object 50. To commence the lifting of the object 50, the second lifting member 296 is driven to rotate so as to move the second lifting assist member 298 and lift the object 50 slightly from its resting surface. In examples in which the first mechanized tool subassembly 280 includes the first lifting member 286, the first lifting member 286 may also be driven to rotate so as to lift the object 50 (from the opposite side wall of object 50) slightly from its resting surface. Thereafter, the second holding members 292 (and/or first holding members 282) may (or may not) assist in lifting the object 50. In some examples, one or more second lifting assist members 298, one or more second lifting members 296, and/or the second lifting member rotary subsystem are in communication with the force assembly 262 so as to assist in measuring, detecting, determining, assessing, analyzing, estimating, or the like, a force applied by and/or onto an object 50, a weight of object 50, and/or one or more dimensions of object 50.

Second Object Managing Systems

Referring now to FIG. 5A and FIG. 5B, two different views of a robotic system 100 are shown in which there is both a first object managing system 200 (as described above) as well as a second object managing system 300, which will be described in some detail below. As significant detail regarding the first managing system 200 has been described, less detail regarding the second object managing system is provided below to avoid redundancy. Reference numerals in the second object managing system 300 are coordinated with reference numbers of the first object managing system 200, with the difference being only found at the hundreds placeholder, e.g., EOAT assembly 270 of object managing system 200 would include the same or similar disclosure compared to EOAT assembly 370 of object managing system 300.

In accordance with this and as shown in FIGS. 5A and 5B, a robotic system 100 may include a first object managing system 200 and a second object managing system 300. The second object managing system 300 may include one or more second vertical assemblies 310, one or more second arm assemblies (combination of 330, 340, 350, and 360), and one or more second end of tool (EOAT) assemblies 370, as shown by way of example at FIGS. 5A and 5B. Thus, the second vertical assembly 310 may, for example, be associated with one or more second arm assembly connectors 316, one or more second rotary subsystems 293 (not shown, but analogous structure shown in FIG. 3A at 211), and one or more second vertical motion subsystems (not shown, but analogous structure shown in FIG. 3A at 217). The second arm assembly may include a second proximal arm segment 330, a second proximal joint 340, a second proximal joint driving subsystem (not shown, but analogous structure shown in FIG. 3A at 241) a second distal arm segment 350, a second distal joint 360, and a second distal joint driving subsystem (not shown, but shown in FIG. 3A at 261). Although the present disclosure may describe the second arm assembly as including one second proximal arm segment 330, one second proximal joint 340, one second proximal joint driving subsystem, one second distal arm segment 350, one second distal joint 360, and one second distal joint driving subsystem, it is to be understood that examples of the second arm assembly may include more or less than one second proximal arm segment 330, more or less than one second proximal joint 340, more or less than one second proximal joint driving subsystem, more or less than one second distal arm segment 350, more or less than one second distal joint 360, and/or more or less than one second distal joint driving subsystem without departing from the teachings of the present disclosure. Similar to the first object managing system 200 (see FIGS. 3A-4K), the second EOAT assembly 370 may include a second tool base subassembly 372, a third mechanized tool subassembly 380 (or second “first mechanized tool subassembly” 380), and a fourth mechanized tool subassembly 390 (or second “second mechanized tool subassembly” 390).

The second tool base subassembly 372 may include a third subassembly member connector (or second “first subassembly member connector”), a fourth member connector (or second “first subassembly member connector”), a third horizontal motion subsystem (or second “first horizontal motion subsystem), and/or a fourth horizontal motion subsystem (or second “second horizontal motion subsystem”). Note that to avoid unnecessary redundancy, these subassemblies and subsystems are not shown in FIGS. 5A and 5B, but analogous structures are shown in FIG. 4A at 274, 276, 278, and 279, respectively. Furthermore, although the present disclosure may describe the second tool base subassembly 372 as including one third subassembly member connector, one fourth subassembly member connector, one third horizontal motion subsystem, and one fourth horizontal motion subsystem, it is to be understood that examples of the second tool base subassembly 372 may include more or less of these structures and/or systems without departing from the teachings of the present disclosure.

The third mechanized tool subassembly 380 may include a third holding member (or second “first holding member), a third holding member joint (or second “first holding member joint”), a third rotary subsystem (or second “first rotary subsystem”), a third opening (or second “first opening”), a third lifting member (or second “first lifting member”), a third lifting member rotary subsystem (or second “first lifting member rotary subsystem”), and/or a third lifting assist member (or second “first lifting assist member”). Note that to avoid unnecessary redundancy, these structures are not shown in FIGS. 5A and 5B, but analogous structures are shown in FIG. 4A at 282, 284, 283, 285, 286, and 288, respectively. Although the present disclosure may describe the third assembly 380 as including one third holding member, one third holding member joint, one third rotary subsystem, one third opening, one third lifting member, one third lifting member rotary subsystem, and one third lifting assist member, it is to be understood that examples of the third assembly 380 may include more or less of these structures and/or systems without departing from the teachings of the present disclosure.

The fourth mechanized tool subassembly 390 may include a fourth holding member (or second “second holding member”), a fourth holding member joint (or second “second holding member joint”), a fourth rotary subsystem (or second “second rotary subsystem”), a fourth opening (or second “second opening”), a fourth lifting member (or second “second lifting member”), a fourth lifting member rotary subsystem (or second “second lifting member rotary subsystem”), and a fourth lifting assist member (or second “second lifting assist member”). Note that to avoid unnecessary redundancy, these structures and subsystems are not shown in FIGS. 5A and 5B, but analogous structures are shown in FIG. 4A at 292, 294, 293, 295, 296, 297, and 298, respectively. Although the present disclosure may describe the fourth mechanized tool subassembly 390 as including one fourth holding member, one fourth holding member joint, one fourth rotary subsystem, one fourth opening, one fourth lifting member, one fourth lifting member rotary subsystem, and one fourth lifting assist member, it is to be understood that examples of the fourth mechanized tool subassembly 390 may include more or less than one of these structures and/or subsystems without departing from the teachings of the present disclosure.

As with the first object managing system, the second object managing system 300 can be configurable or configured to autonomously, semi-autonomously, and/or be controlled to manage one or more objects 50. In some examples, the second object managing system 300 may include one or more second vertical assemblies 310 configurable or configured to enable the second object managing system 300 to provide at least 2 degrees of freedom (DOF) of movement for the second EOAT assembly 370. The second object managing system 300 may also include one or more second arm assemblies (see combination of 330, 340, 350, 360) to enable the second object managing system 300 to provide at least 2 degrees of freedom (DOF) of movement for the second EOAT assembly 370. The second object managing system 300 may also include one or more second end of tool (EOAT) assemblies 370. Similar to the EOAT assembly 270 described previously, the second EOAT assembly 370 can be configurable or configured to hold, lift, secure, grasp, or the like, one or more objects 50.

Thus, in some examples, the second object managing system 300 may include the same or similar structural components as that described with respect to the first object managing system 200. To that end, these multiple object managing systems can be configured identically or differently. For example, the two object managing systems may be configured as mirror images of one another, or may be configured redundantly (not a mirror image). Furthermore, the various components of the respective object managing systems may be selected to be identical or different, such as in size, material, weight, operation, etc. Furthermore, certain components may be omitted relative to the other object managing system. In short, the second object managing system 300, if present, may include some or all of the same structures as found in the first object managing system 200, and when the same type of structure is present, that structure or component may be the same or different in configuration. Example structures that can be the same or different (or present vs. not present) in the multiple object managing systems may include, for example, the vertical assemblies, the arm assembly connectors, the rotary subsystems, the vertical motion subsystems, the arm assemblies, the proximal arm segments, the proximal joints, the proximal joint driving subsystems, the distal arm segments, the distal joints, the distal joint driving subsystems, the horizontal motion subsystems, the end of arm tool (EOAT) assemblies and their respective components, e.g., tool base subassemblies, first and second mechanized tool subassemblies, etc.

Controllers

In more specific detail regarding controlling the robotic systems 100 and/or any of the assemblies, subassemblies, or subsystems thereof, reference is now made to FIGS. 6 and 7. More specifically, FIG. 6 illustrates a schematic diagram of example computing systems/controllers 400 usable with the robotic systems or assemblies, subassemblies, or subsystems thereof in accordance with of the present disclosure. The computing systems or controllers 400 usable with the robotic systems or assemblies, subassemblies, or subsystems thereof can include any of a number of processors 410, I/O devices 420, network devices 430, and memory devices 440. The memory devices 440 may include a data store 450 and/or various modules 460. The computing systems or controllers 400 may be connected with a display and/or control interface 470, for example, for human interface with the computing systems or controllers 400, for example.

FIG. 7 illustrates a schematic diagram of example robotic system with computing systems or controllers 400 that are adapted to control various other systems, assemblies, subsystems, subassemblies, devices, etc. More specifically, various controller(s) 400 may include and/or cooperate with any processor, server, system, device, computing device, other controller, microprocessor, microcontroller, microchip, semiconductor device, computer network, cloud computing, artificial intelligence (AI), machine learning, deep learning, or the like. The controller(s) 400 may be configurable or configured to perform or enable autonomous, semi-autonomous, and/or user-controller managing, including controlling, monitoring, etc., of one or more elements, aspects, functionalities, operations, and/or processes of the robotic system 100.

In one example, the controller(s) 400 shown in FIG. 7 may be configurable or configured to manage and/or control one or more elements, aspects, functionalities, operations, and/or processes of the mobile vehicle 40 (or any other structure that where an object managing system is mounted). For example, the controller(s) 400 may be configurable or configured to manage and/or control movement of the mobile vehicle 40 from one location to another location, including controlling one or more cylindrical rotatable drive member 20 which drives a conveyer belt 1, the wheels 14 and/or stabilizing assembly 16, an onboard air box 24, a variety of perception sensors 26a, 26b, and 266, sound emitters 30a, light emitters 30b, and a power source 32.

The controller(s) 400 may also be configurable or configured to manage and/or control one or more elements, aspects, functionalities, operations, and/or processes of the vertical assembly 210. For example, the controller(s) 400 may be configurable or configured to manage and/or control the support rotary subsystem 211 to selectively rotate the arm assembly connector 216 relative to the vertical Axis A (see FIG. 3A). As another example, the controller(s) 400 may be configurable or configured to manage and/or control the vertical motion subsystem 217 to selectively move the arm assembly connector 216 along the vertical Axis A between the first end 210a and second end 210b of the vertical assembly 210 (see FIG. 3A).

The controller(s) 400 may also be configurable or configured to manage and/or control one or more elements, aspects, functionalities, operations, and/or processes of the arm assembly 220. For example, the controller(s) may be configurable or configured to manage and/or control the proximal joint 240 to selectively rotate the proximal joint 240 relative to the proximal joint Axis C. As another example, the controller(s) 400 may be configurable or configured to manage and/or control the distal joint driving subsystem 261 to selectively rotate the distal joint 260 relative to the distal joint Axis E.

The controller(s) 400 may also be configurable or configured to manage and/or control one or more elements, aspects, functionalities, operations, and/or processes of the EOAT assembly 270. For example, the controller(s) 400 may be configurable or configured to manage and/or control the first horizontal motion subsystem 278 to selectively move the first subassembly member connector 274 between the first end 272a of the tool base subassembly 272 and the center region of the tool base subassembly 272. As another example, the controller(s) 400 may be configurable or configured to manage and/or control the second horizontal motion subsystem 279 to selectively move the second subassembly member connector 276 between the second end 272b of the tool base subassembly 272 and the center region of the tool base subassembly 272. As another example, the controller(s) 400 may be configurable or configured to manage and/or control the first tool rotary subsystem 283 to selectively rotate the second end of the first holding member joint 284 (and/or rotate the first holding member 282) relative to the first holding member joint Axis K. As another example, the controller(s) 400 may be configurable or configured to manage and/or control the first lifting member rotary subsystem 287 to selectively rotate the cylindrical body of the first lifting member 286 relative to the first lifting Axis J. As another example, the controller(s) 400 may be configurable or configured to manage and/or control the second tool rotary subsystem 293 to selectively rotate the second end 294 of the second holding member joint 294 (and/or rotate the second holding member 292) relative to the second holding member joint Axis N. As another example, the controller(s) 400 may be configurable or configured to manage and/or control the second lifting member rotary subsystem 297 to selectively rotate the cylindrical body of the second lifting member 296 relative to the second lifting Axis M.

The controller(s) 400 may also be configurable or configured to manage and/or control one or more image capturing devices, e.g., a video camera, etc., provided at one or more parts of the robotic system 100. Such video and/or still images captured by the one or more image capturing devices may be processed and used by the controller(s) 400 to perform a variety of operations and actions. For example, the captured video and/or still images may be used to identify and/or estimate a location, position, orientation, size, dimension, or the like, of the object 50. As another example, the captured video and/or still images may be processed and used by the controller(s) 400 to manage and/or control one or more elements and/or actions of the robotic system 100.

In additional detail, additional components may be included in the robotic systems 100 of the present disclosure that may also be robotically controlled by one or more controllers. For example, the robotic system 100 may include global positioning sensors (GPS), optical cameras, infra-red (IR) cameras or sensors, LIDAR sensors, pressure sensors, force sensors, inertial measurement unit sensors, rangefinders, and others, or any combination of these. In some examples, these components may be embedded or attached to any of the components of the robotic systems 100 described herein. In some examples, there may be a single coordinated controller, or there may be multiple controllers that coordinate robotic positioning. For example, there may be a system controller that is able to communicate and coordinate with other sub-controllers to communicate with each of these and receive data therefrom.

As an example, in the case of the robotic system 100 being integrated as part of a mobile vehicle 40, the controller(s) 400 may manipulate the location of the mobile vehicle, e.g., driven, steered, speed control, breaking, etc., to bring and position the robotic object managing system(s) in close proximity to an object to be manipulated, lifted, moved, etc., such as from the conveyer belt to a second location. In certain examples, the controllers can use one or more of any of the sensors, e.g., perception sensors, to perceive the operating environment and locate landmarks, objects, etc., such as a stack of objects to be acquired and managed, other objects that might be impeding or blocking a travel route, etc. The controller(s) 400 can likewise operate to autonomously or receive inputs from a display or control interface 28 to allow an operator to manually manipulate the robotic system 100 or any subassembly thereof.

In a specific example regarding perception sensing, the controller(s) 400 can access and control optical cameras, IR cameras, LIDAR sensors, and any sensors to facilitate recognition and locating of one or more objects to be managed, such as a target object. For instance, the controller(s) can receive a two dimensional (2D) image from an optical camera for processing to roughly locate an object, e.g., a target object, using machine vision techniques, such as edge detection or blob analysis. The controller(s) 400 can also (or alternatively) receive three dimensional (3D) data from a stereo image provided by a pair of optical cameras configured to facilitate stereo imaging or IR cameras. The data can be analyzed to map a precise location and orientation of the target object, as well as other, etc., at or around the target object. The controller(s) 400 can operate as a perception sensors for the robotic system 100 or any subassembly thereof to assist in acquiring a target object from a first location and releasing the target object at a specific position and/or orientation in a second location. The first or second location may be from the conveyer belt 12 of the mobile vehicle 40, for example. Such perception sensors in combination with the controller(s) 400 can likewise access other sensors, such as a force sensor, a LIDAR sensor and/or a rangefinder sensor to provide additional 2D and 3D information about the surroundings and operation of the various components of the robotic systems 10.

In this example, the controller(s) 400 can communicate with and control the various components or subsystems associated with robotic positioning, such as the manipulation of various joints, actuators, motors, and/or structures associated therewith in order to position the object managing system(s) 200 and/or 300 to facilitate acquiring, manipulating and releasing a target object. The controller(s) can also access or include one or more of the perception sensors to facilitate proper positioning, operation, and control for robotic positioning.

For 2D sensing, high resolution color imagery can be captured with one or more optical cameras. The 2D data can then be correlated with concurrently captured 3D depth and point cloud data, captured from sensors such as multiple IR cameras, a LIDAR sensor, and/or rangefinder sensors (such as time-of-flight sensors). The 3D data can also include camera data captured by a pair of stereoscopic optical cameras, which allows for a processors to triangulate objects within an environment. As an example, detection of a target object in the form of a luggage bag can involve processing 2D image data for a large, often black, reflective rectangle shaped object using a blob analysis algorithm, and then employ an edge detection mechanism to project the sides and comers of the luggage bag. The 2D edge and corner data can then be correlated to the 3D data to project a plane for a top surface, a bottom surface, and/or a side surface of the luggage bag. Once a 3D desired plane is determined for the luggage bag, the EOAT assembly 270 of an object managing system can be positioned using this information to acquire the luggage bag. The perception sensors, operating in conjunction with the controller(s) 400 can use algorithms to detect the edges, corners, and other uniquely identifiably features of the target object, other objects or structures around the target object, a location or structure that is to receive the released target object, etc., to define the 3D representation of these. For instance, if the luggage bag is to be placed upon a conveyor belt, this allows determination of the 3D position and orientation of the conveyor with respect to the sensor(s) and also the acquired target object. This information can inform the EOAT assembly how to move in order to place the luggage bag correctly with respect to the conveyor system and its position and orientation.

It is noted herein that any of the controller(s) 400 discussed and disclosed herein can comprise similar components, and discussed above. It is also noted that any of the controller(s) discussed and disclosed herein can be configured to communicate and control any of the elements of the systems, subsystems, assemblies, subassemblies, devices, components, etc., of the robotic system 100, not just the particular components of the specific device or system in which the controller(s) reside. For example, a controller 400 located within the mobile vehicle 40 can control any components or all components of the object managing system or systems. Controller(s) may also be located remotely, connecting wirelessly with any component of the robotic system 100. However configured or wherever located, the controller(s) 400 can include all of the hardware and/or software components to facilitate the communication and control of the robotic system 100 or components thereof with respect to whatever example robotics are designed and implemented in accordance with the present disclosure.

### Example Embodiments

In accordance with the disclosure herein, the following examples are illustrative of several embodiments of the present technology.

1. An example EOAT assembly, comprising:
a tool base subassembly having a tool base attachment surface;
a first mechanized tool subassembly movably attached to the tool base subassembly along the tool base attachment surface, the first mechanized tool subassembly including:
   a first elongated body oriented orthogonally relative to the tool base attachment surface, and
   a first holding member attached to the first elongated body, the first holding member having an engaged position to pass beneath an object to assist with lifting of the object and a disengaged position that does not contribute to lifting of the object;
a second mechanized tool subassembly movably attached to the tool base subassembly along the tool base attachment surface, the second mechanized tool subassembly including:
   a second elongated body oriented orthogonally relative to the tool base attachment surface, and
   a second holding member attached to the second elongated body, the second holding member having an engaged position to pass beneath an object to assist with lifting of the object and a disengaged position that does not contribute to lifting of the object;
wherein movement of first and second mechanized tool assemblies along the tool base attachment surface provides for opening and partially closing of a gap there between to laterally provide space for engaging with the object followed by squeezing the object for lifting.

2. The EOAT assembly of example 1, wherein the tool base subassembly is connected to an arm assembly of an object managing system.

3. The EOAT assembly of any one of examples 1-2, further comprising a first horizontal motion subsystem to selectively move the first elongated body along the tool base attachment surface between a first end of the tool base subassembly toward a center region of the tool base subassembly.

4. The EOAT assembly of example 3, further comprising a second horizontal motion subsystem to selectively move the second elongated body along the tool base attachment surface between a second end of the tool base subassembly toward the center region of the tool base subassembly.

5. The EOAT assembly of any one of examples 1-4, further comprising a first holding member joint connecting the first elongated body to the first holding member, wherein articulation of the first holding member joint transitions the first holding member between its engaged position and it disengaged position.

6. The EOAT assembly of example 5, further comprising a second holding member joint connecting the second elongated body to the second holding member, wherein articulation of the second holding member joint transitions the second holding member between its engaged position and it disengaged position.

7. The EOAT assembly of any one of examples 1-6, further comprising a first lifting member secured to the first elongated body and adjacent to a first opening through the first elongated body, wherein the first lifting member is movable relative to the first opening to protrude or protrude further through the first opening, or to cause a first lifting assist member to protrude or protrude further into the gap to assist with object engagement for lifting.

8. The EOAT assembly of any one of example 7, wherein rotation of the first lifting member causes the first lifting assist member to protrude or protrude further into the gap.

9. The EOAT assembly of any one of examples 7-8, further comprising a second lifting member secured to the second elongated body and adjacent to a second opening through the second elongated body, wherein the second lifting member is movable relative to the second opening to protrude or protrude further through the second opening, or to cause a second lifting assist member to protrude or protrude further into the gap to assist with object engagement for lifting.

10. The EOAT assembly of example 9, wherein rotation of the second lifting member causes the second lifting assist member to protrude or protrude further into the gap.

11. An example robotic system for managing objects, comprising:
an EOAT assembly including holding members having an engaged position to pass beneath an object to assist with lifting of the object and a disengaged position that does not contribute to lifting of the object; and
a conveyer system including:
   a plurality of conveyer belt supports to support objects placed thereon,
   conveyer belt support spacing between adjacent conveyer belt supports, wherein the conveyer belt support spacing is configured to receive holding members in both the engaged and the disengaged position such that the holding members may be placed beneath the objects on the conveyer belt supports for lifting;
   at least one rotatable drive member, and
   a conveyer belt engaged with the rotatable drive member to generate conveyer belt movement along a working surface of the conveyer belt, wherein the conveyer belt passes over the plurality of conveyer belt supports and wherein the conveyer belt is narrower in a direction orthogonal to the direction of belt movement compared to the conveyer belt supports to provide access for the holding members into the conveyer belt support spacing.

12. The robotic system of example 11, wherein the EOAT assembly further includes a pair of mechanized tool assemblies to provide coordinated lateral movement for opening a gap there between to laterally provide space for engaging with an object and partially closing the gap to squeeze the object for lifting.

13. The robotic system of example 12, wherein the pair of mechanized tool assemblies each include at least one of the holding members associated therewith, wherein lifting is configured to occur when the pair of mechanized tool assemblies is squeezing the object laterally and the holding members are in the engaged position beneath the object.

14. The robotic system of any one of examples 12-13, further comprising a tool base subassembly, wherein the pair of mechanized tool assemblies are each connected orthogonally to the tool base subassembly for lateral translation along a tool base attachment surface of the tool base assembly causes the opening and partial closing of the gap.

15. The robotic system of any one of examples 11-14, wherein one or both of the pair of mechanized tool assemblies include an opening therethrough for engagement of a lifting member or a lifting assist member as one or both protrude or protrude further into the gap.

16. The robotic system of any one of examples 11-15, wherein the EOAT assembly is rotationally connected to an arm assembly.

17. The robotic system of example 16, wherein the arm assembly includes multiple arm segments and multiple arm joints to provide three-dimensional manipulation of the EOAT assembly.

18. The robotic system of example 17, wherein the arm assembly is also connected at or near at an opposite end thereof to an arm assembly connector of vertical assembly to provide vertical movement of the arm assembly.

19. The robotic system of example 18, wherein the vertical assembly is rotational attached to a support base.

20. The robotic system of example 19, wherein the support base is on a mobile vehicle.

21. The robotic system of any one of examples 11-20, further comprising a second EOAT assembly.

22. The robotic system of example 21, wherein the second EOAT assembly includes holding members having an engaged position to pass beneath an object to assist with lifting of the object and a disengaged position that does not contribute to lifting of the object.

23. The robotic system of any one of examples 21-22, wherein the EOAT assembly includes a pair of mechanized tool assemblies to provide coordinated lateral movement for opening a gap there between to laterally provide space for engaging with an object and partially closing the gap to squeeze the object for lifting.

24. The robotic system of example 23, wherein one or both of the pair of mechanized tool assemblies include an opening therethrough for engagement of a lifting member or a lifting assist member as one or both protrude or protrude further into the gap.

25. The robotic system of any one of examples 21-24, wherein the EOAT assembly and the second EOAT assembly are configured as mirror images of one another.

26. The robotic system of any one of examples 21-25, wherein the EOAT assembly and the second EOAT assembly both positioned on a mobile vehicle.

27. A method of managing objects, comprising:
identifying an object on a surface to be manipulated by an EOAT assembly of a robotic system;
orienting a pair mechanized tool subassemblies about an object, wherein the pair of mechanized tool subassemblies each include one or more holding members having an engaged position and a disengaged position, wherein prior to engaging the object, the holding members are in the disengaged position;
squeezing the object between the pair of mechanized tool subassemblies;
moving the holding members from the disengaged position to the engaged position;
manipulating the object while squeezed between the pair of mechanized tool subassemblies and while the holding members are positioned beneath the object to provide support thereto.

28. The method of example 27, wherein the EOAT assembly further includes a tool base subassembly having a tool base attachment surface, wherein squeezing the object occurs by coordinated lateral movement of the pair of mechanized tool subassemblies to partially closing a gap there between.

29. The method of example 28, wherein the pair of mechanized tool subassemblies each include at least one of the holding members associated therewith, wherein manipulating the object occurs when the pair of mechanized tool subassemblies is squeezing the object laterally and the holding members are in the engaged position beneath the object.

30. The method of any one of examples 27-29, wherein the EOAT assembly further comprises a tool base subassembly, wherein the pair of mechanized tool assemblies are each connected orthogonally to the tool base subassembly for lateral translation along a tool base attachment surface of the tool base assembly causes the opening and partial closing of the gap.

31. The method any one of examples 27-30, wherein one or both of the pair of mechanized tool assemblies include an opening therethrough, wherein manipulating the object is assisted by engagement of a lifting member or a lifting assist member as one or both protrude or protrude further into the gap.

32. The method of any one of examples 27-31, wherein orienting the pair of mechanized tool subassemblies includes rotating the EOAT assembly relative to an arm assembly.

33. The method of any one of examples 27-32, wherein orienting the pair of mechanized tool subassemblies includes moving multiple arm segments of the arm assembly at arm joints.

34. The method of any one of examples 27-33, wherein orienting the pair of mechanized tool subassemblies includes moving the arm assembly vertically along a vertical assembly.

35. The method of example 34, wherein orienting the pair of mechanized tool subassemblies includes rotating the vertical assembly relative to a support base.

36. The method of any one of examples 27-35, wherein orienting the pair of mechanized tool subassemblies includes:
rotating the EOAT assembly relative to an arm assembly,
moving multiple arm segments of the arm assembly at arm joints,
moving the arm assembly vertically along a vertical assembly, and
rotating the vertical assembly relative to a support base, to provide three-dimensional manipulation of the EOAT assembly.

37. The method of any one of examples 27-36, wherein the EOAT assembly is connected to a mobile vehicle, and wherein orienting the pair of mechanized tool subassemblies includes moving the mobile vehicle in proximity to one or more objects to be manipulated.

38. A system for managing objects, comprising:
a vertical assembly, the vertical assembly formed as an elongated body with a first end, a second end, and a vertical axis formed through the elongated body of the vertical assembly between the first and second ends of the vertical assembly, the first end of the vertical assembly secured to the support body, the vertical assembly including:
an arm assembly connector;
a rotary subsystem, the rotary subsystem configured to selectively rotate the arm assembly connector relative to the vertical axis; and
a vertical motion subsystem, the vertical motion subsystem configured to selectively move the arm assembly connector along the vertical axis between the first and second ends of the vertical assembly;
an arm assembly, the arm assembly including:
a proximal arm segment, the proximal arm segment formed as an elongated body with a first end, a second end, and a first horizontal axis formed through the elongated body of the proximal arm segment between the first and second ends of the proximal arm segment, the first end of the proximal arm segment secured to the arm assembly connector, the proximal arm segment configured to selectively rotate relative to the vertical axis when the rotary subsystem of the vertical assembly selectively rotates the arm assembly connector relative to the vertical axis, the proximal arm segment configured to selectively move along the vertical axis between the first and second ends of the vertical assembly when the vertical motion subsystem of the vertical assembly selectively moves the arm assembly connector along the vertical axis between the first and second ends of the vertical assembly, wherein the first horizontal axis is orthogonal to the vertical axis;
a proximal joint, the proximal joint having a first end, a second end, and a proximal joint axis formed between the first and second ends of the proximal joint, the proximal joint axis being parallel to the vertical axis, the first and second ends of the proximal joint configured to selectively rotate relative to the proximal joint axis, wherein the first end of the proximal joint is secured to the second end of the proximal arm segment;
a distal arm segment, the distal arm segment formed as an elongated body with a first end, a second end, and a second horizontal axis formed through the elongated body of the distal arm segment between the first and second ends of the distal arm segment, the first end of the distal arm segment secured to the second end of the proximal arm joint, the distal arm segment configured to selectively rotate relative to the proximal joint axis; and
a distal joint, the distal joint having a first end, a second end, and a distal joint axis formed between the first and second ends of the distal joint, the distal joint axis being parallel to the vertical axis, the first and second ends of the distal joint configured to rotate relative to the distal joint axis, wherein the first end of the distal joint is secured to the second end of the distal arm segment; and
an end of arm tool (EOAT) assembly, the EOAT assembly including:
a tool base subassembly, the tool base subassembly formed as an elongated body with a left end, a right end, a center region between the left and right ends of the tool base subassembly, and a rear axis formed through the elongated body of the tool base subassembly between the left and right ends of the tool base subassembly, the tool base subassembly secured to the second end of the distal joint, the tool base subassembly configured to selectively rotate relative to the distal joint axis, the tool base subassembly including:
a first member connector; a second member connector;
a left horizontal motion subsystem, the left horizontal motion subsystem configured to selectively move the first member connector between the left end of the tool base subassembly and the center region of the tool base subassembly;
a right horizontal motion subsystem, the right horizontal motion subsystem configured to selectively move the second member connector between the right end of the tool base subassembly and the center region of the tool base subassembly;
a first mechanized tool subassembly, the first mechanized tool subassembly formed as an elongated body with a front end, a rear end, a top end, a bottom end, and a first axis formed through the elongated body of the first mechanized tool subassembly between the front and rear ends of the first mechanized tool subassembly, the rear end of the first mechanized tool subassembly secured to the first member connector, the first mechanized tool subassembly configured to selectively move between the left end of the tool base subassembly and the center region of the tool base subassembly when the left horizontal motion subsystem selectively moves the first member connector between the left end of the tool base subassembly and the center region of the tool base subassembly, the first axis being orthogonal to the rear axis, the first mechanized tool subassembly including:
a first holding member joint, the first holding member joint having a first end, a second end, and a first holding member joint axis formed between the first and second ends of the first holding member joint, the first holding member joint axis being parallel to the first axis, the second end of the first holding member joint configured to rotate relative to the first holding member joint axis, wherein the first end of the first holding member joint is secured to a first portion of the bottom end of the first mechanized tool subassembly;
a first rotary subsystem, the first rotary subsystem configured to selectively rotate the second end of the first holding member joint relative to the first holding member joint axis;
a left holding member, the left holding member secured to the second end of the first holding member joint, the left holding member configured to rotate relative to the first holding member joint axis when the first rotary subsystem rotates the second end of the first holding member joint relative to the first holding member joint axis;
a first opening formed through the elongated body of the first assembly;
a first lifting member, the first lifting member formed as a cylindrical body rotatable relative to a first lifting axis, the first lifting axis formed through the cylindrical body of the first lifting member and parallel to the first axis, the first lifting member secured to the first mechanized tool subassembly in such a way that at least a portion of the cylindrical body of the first lifting member protrudes through the first opening; and
a first lifting member rotary subsystem, the first lifting member rotary subsystem configured to selectively rotate the cylindrical body of the first lifting member relative to the first lifting axis;
a second mechanized tool subassembly, the second mechanized tool subassembly formed as an elongated body with a front end, a rear end, a top end, a bottom end, and a second axis formed through the elongated body of the second mechanized tool subassembly between the front and rear ends of the second mechanized tool subassembly, the rear end of the second mechanized tool subassembly secured to the second member connector, the second mechanized tool subassembly configured to selectively move between the right end of the tool base subassembly and the center region of the tool base subassembly when the right horizontal motion subsystem selectively moves the second member connector between the right end of the tool base subassembly and the center region of the tool base subassembly, the second axis being orthogonal to the rear axis, the second axis being parallel to the first axis.

39. The system of example 38, wherein the second mechanized tool subassembly includes:
a second holding member joint, the second holding member joint having a first end, a second end, and a second holding member joint axis formed between the first and second ends of the second holding member joint, the second holding member joint axis being parallel to the second axis, the second end of the second holding member joint configured to rotate relative to the second holding member joint axis, wherein the first end of the second holding member joint is secured to a first portion of the bottom end of the second mechanized tool subassembly;
a second rotary subsystem, the second rotary subsystem configured to selectively rotate the second end of the second holding member joint relative to the second holding member joint axis;
a right holding member, the right holding member secured to the second end of the second holding member joint, the right holding member configured to rotate relative to the second holding member joint axis when the second rotary subsystem rotates the second end of the second holding member joint relative to the second holding member joint axis;
a second opening formed through the elongated body of the second mechanized tool subassembly; a second lifting member, the second lifting member formed as a cylindrical
body rotatable relative to a second lifting axis, the second lifting axis formed through the cylindrical body of the second lifting member and parallel to the second axis, the second lifting member secured to the second mechanized tool subassembly in such a way that at least a portion of the cylindrical body of the second lifting member protrudes through the second opening; and
a second lifting member rotary subsystem, the second lifting member rotary subsystem configured to selectively rotate the cylindrical body of the second lifting member relative to the second lifting axis.

40. The system of any one of examples 38-39, wherein the cylindrical body of the first lifting member rotates in a first direction; wherein the cylindrical body of the second lifting member rotates in a second direction opposite to the first direction.

41. The system of any one of examples 38-40, wherein the elongated body of the first mechanized tool subassembly is formed as a planar body; wherein the elongated body of the second mechanized tool subassembly is formed as a planar body; and wherein the planar body of the first mechanized tool subassembly and the planar body of the second mechanized tool subassembly are parallel to one another.

42. The system of any one of examples 38-41, wherein the first mechanized tool subassembly further comprises:
a first lifting assist member, the first lifting assist member formed as a planar body with an outer surface and an inner surface opposite to the outer surface, the first lifting assist member secured to the first mechanized tool subassembly in such a way that the inner surface of the first lifting assist member is in contact with at least an outer surface of the cylindrical body of the first lifting member;
wherein, when the cylindrical body of the first lifting member rotates in a first direction, the first lifting assist member is configured to move along with the rotation of the cylindrical body of the first lifting member.

43. The system of example 39, wherein the second mechanized tool subassembly further comprises:
a second lifting assist member, the second lifting assist member formed as a planar body with an outer surface and an inner surface opposite to the outer surface, the second lifting assist member secured to the second mechanized tool subassembly in such a way that the inner surface of the second lifting assist member is in contact with at least an outer surface of the cylindrical body of the second lifting member;
wherein, when the cylindrical body of the second lifting member rotates in a second direction, the second lifting assist member is configured to move along with the rotation of the cylindrical body of the second lifting member.

44. The system of any one of examples 38-43, further comprising a main controller, the main controller configurable to perform at least one of the following:
control the rotary subsystem to selectively rotate the arm assembly connector relative to the vertical axis;
control the vertical motion subsystem to selectively move the arm assembly connector along the vertical axis between the first and second ends of the vertical assembly;
control the proximal joint to selectively rotate the second end of the proximal joint relative to the proximal joint axis;
control the distal joint to selectively rotate the second end of the distal joint relative to the distal joint axis;
control the left horizontal motion subsystem to selectively move the first member connector between the left end of the tool base subassembly and the center region of the tool base subassembly;
control the right horizontal motion subsystem to selectively move the second member connector between the right end of the tool base subassembly and the center region of the tool base subassembly;
control the first rotary subsystem to selectively rotate the second end of the first holding member joint relative to the first holding member joint axis; and
control the first lifting member rotary subsystem to selectively rotate the cylindrical body of the first lifting member relative to the first lifting axis.

45. The system of example 39, further comprising a main controller, the main controller configurable to perform at least one of the following:
control the rotary subsystem to selectively rotate the arm assembly connector relative to the vertical axis;
control the vertical motion subsystem to selectively move the arm assembly connector along the vertical axis between the first and second ends of the vertical assembly;
control the proximal joint to selectively rotate the second end of the proximal joint relative to the proximal joint axis;
control the distal joint to selectively rotate the second end of the distal joint relative to the distal joint axis;
control the left horizontal motion subsystem to selectively move the first member connector between the left end of the tool base subassembly and the center region of the tool base subassembly;
control the right horizontal motion subsystem to selectively move the second member connector between the right end of the tool base subassembly and the center region of the tool base subassembly;
control the first rotary subsystem to selectively rotate the second end of the first holding member joint relative to the first holding member joint axis;
control the first lifting member rotary subsystem to selectively rotate the cylindrical body of the first lifting member relative to the first lifting axis;
control the second rotary subsystem to selectively rotate the second end of the second holding member joint relative to the second holding member joint axis; and
control the second lifting member rotary subsystem to selectively rotate the cylindrical body of the second lifting member relative to the second lifting axis.

46. The system of any one of examples 38-45, wherein the first mechanized tool subassembly further comprises:
a second first holding member joint, the second first holding member joint having a first end, a second end, and a second first holding member joint axis formed between the first and second ends of the second first holding member joint, the second first holding member joint axis being parallel to the first axis, the second end of the second first holding member joint configured to rotate relative to the second first holding member joint axis, wherein the first end of the second first holding member joint is secured to a second portion of the bottom end of the first mechanized tool subassembly;
a second first rotary subsystem, the second first rotary subsystem configured to selectively rotate the second end of the second first holding member joint relative to the second first holding member joint axis;
a second left holding member, the second left holding member secured to the second end of the second first holding member joint, the second left holding member configured to rotate relative to the second first holding member joint axis when the second first rotary subsystem rotates the second end of the second first holding member joint relative to the second first holding member joint axis.

47. The system of any one of examples 38-46, wherein the first mechanized tool subassembly further comprises:
a second left holding member, the second left holding member secured to the second end of the second first holding member joint, the second left holding member configured to rotate relative to the first holding member joint axis when the first rotary subsystem rotates the second end of the first holding member joint relative to the first holding member joint axis;
wherein the second end of the first holding member joint is formed as an elongated member having a front end and a rear end;
wherein the left holding member is secured to the front end of the elongated member of the second end of the first holding member joint; and
wherein the second left holding member is secured to the rear end of the elongated member of the second end of the first holding member joint.

48. A robotic system for managing objects, the system comprising:
an arm assembly, the arm assembly having at least 4 degrees of freedom; and an end of arm tool (EOAT) assembly, the EOAT assembly including:
a tool base subassembly, the tool base subassembly formed as an elongated body with a first end, a second end, a center region between the first and second ends of the tool base subassembly, and a rear axis formed through the elongated body of the tool base subassembly between the first and second ends of the tool base subassembly, the tool base subassembly secured to the arm assembly, the tool base subassembly including:
a first subassembly member connector;
a second subassembly member connector;
a first horizontal motion subsystem, the first horizontal motion subsystem configured to selectively move the first subassembly member connector between the first end of the tool base subassembly and the center region of the tool base subassembly;
a second horizontal motion subsystem, the second horizontal motion subsystem configured to selectively move the second subassembly member connector between the second end of the tool base subassembly and the center region of the tool base subassembly;
a first mechanized tool subassembly, the first mechanized tool subassembly formed as an elongated body with a front end, a rear end, a top end, a bottom end, and a first axis formed through the elongated body of the first mechanized tool subassembly between the front and rear ends of the first mechanized tool subassembly, the rear end of the first mechanized tool subassembly secured to the first subassembly member connector, the first mechanized tool subassembly configured to selectively move between the first end of the tool base subassembly and the center region of the tool base subassembly when the first horizontal motion subsystem selectively moves the first subassembly member connector between the first end of the tool base subassembly and the center region of the tool base subassembly, the first mechanized tool subassembly including a first opening formed through the elongated body of the first subassembly member connector,
a first lifting member, the first lifting member formed as a cylindrical body rotatable relative to a first lifting axis, the first lifting axis formed through the cylindrical body of the first lifting member, the first lifting member secured to the first mechanized tool subassembly in such a way that at least a portion of the cylindrical body of the first lifting member protrudes through the first opening; and
a first lifting member rotary subsystem, the first lifting member rotary subsystem configured to selectively rotate the cylindrical body of the first lifting member relative to the first lifting axis;
a second mechanized tool subassembly, the second mechanized tool subassembly formed as an elongated body with a front end, a rear end, a top end, a bottom end, and a second axis formed through the elongated body of the second mechanized tool subassembly between the front and rear ends of the second mechanized tool subassembly, the rear end of the second mechanized tool subassembly secured to the second subassembly member connector, the second mechanized tool subassembly configured to selectively move between the second end of the tool base subassembly and the center region of the tool base subassembly when the second horizontal motion subsystem selectively moves the second subassembly member connector between the second end of the tool base subassembly and the center region of the tool base subassembly.

49. The system of example 48, wherein the first mechanized tool subassembly further comprises:
a first lifting assist member, the first lifting assist member formed as a planar body with an outer surface and an inner surface opposite to the outer surface, the first lifting assist member secured to the first mechanized tool subassembly in such a way that the inner surface of the first lifting assist member is in contact with at least an outer surface of the cylindrical body of the first lifting member;
wherein, when the cylindrical body of the first lifting member rotates, the first lifting assist member is configured to move along with the rotation of the cylindrical body of the first lifting member.

50. The system of any one of examples 48-49, wherein the second mechanized tool subassembly includes:
a second opening formed through the elongated body of the second mechanized tool subassembly;
a second lifting member, the second lifting member formed as a cylindrical body rotatable relative to a second lifting axis, the second lifting axis formed through the cylindrical body of the second lifting member and parallel to the second axis, the second lifting member secured to the second mechanized tool subassembly in such a way that at least a portion of the cylindrical body of the second lifting member protrudes through the second opening; and
a second lifting member rotary subsystem, the second lifting member rotary subsystem configured to selectively rotate the cylindrical body of the second lifting member relative to the second lifting axis.

51. The system of example 50, wherein the second mechanized tool subassembly further comprises:
a second lifting assist member, the second lifting assist member formed as a planar body with an outer surface and an inner surface opposite to the outer surface, the second lifting assist member secured to the second mechanized tool subassembly in such a way that the inner surface of the second lifting assist member is in contact with at least an outer surface of the cylindrical body of the second lifting member;
wherein, when the cylindrical body of the second lifting member rotates, the second lifting assist member is configured to move along with the rotation of the cylindrical body of the second lifting member.

52. The system of example 50, wherein the cylindrical body of the first lifting member rotates in a first direction; and wherein the cylindrical body of the second lifting member rotates in a second direction opposite to the first direction.

53. The system of any one of examples 48-52, wherein the elongated body of the first mechanized tool subassembly is formed as a planar body; wherein the elongated body of the second mechanized tool subassembly is formed as a planar body; and wherein the planar body of the first mechanized tool subassembly and the planar body of the second mechanized tool subassembly are parallel to one another.

54. The system of any one of examples 48-53, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly; and control the first lifting member rotary subsystem to selectively rotate the cylindrical body of the first lifting member relative to the first lifting axis.

55. The system of example 50, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly; and
control the first lifting member rotary subsystem to selectively rotate the cylindrical body of the first lifting member relative to the first lifting axis; and
control the second lifting member rotary subsystem to selectively rotate the cylindrical body of the second lifting member relative to the second lifting axis.

56. The system of any one of examples 48-55, wherein the first mechanized tool subassembly further comprises:
a third opening formed through the elongated body of the first mechanized tool subassembly; a third lifting member, the third lifting member formed as a cylindrical
body rotatable relative to a third lifting axis, the third lifting axis formed through the cylindrical body of the third lifting member and parallel to the first axis, the third lifting member secured to the first mechanized tool subassembly in such a way that at least a portion of the cylindrical body of the third lifting member protrudes through the third opening;
a third lifting assist member, the third lifting assist member formed as a planar body with an outer surface and an inner surface opposite to the outer surface, the third lifting assist member secured to the first mechanized tool subassembly in such a way that the inner surface of the third lifting assist member is in contact with at least an outer surface of the cylindrical body of the third lifting member;
wherein, when the cylindrical body of the third lifting member rotates, the third lifting assist member is configured to move along with the rotation of the cylindrical body of the third lifting member.

57. The system of example 56, wherein the first mechanized tool subassembly further comprises:
a third lifting member rotary subsystem, the third lifting member rotary subsystem configured to selectively rotate the cylindrical body of the third lifting member relative to the third lifting axis.

58. The system of any one of examples 56-57, wherein the first lifting member rotary subsystem is further configured to selectively rotate the cylindrical body of the third lifting member relative to the third lifting axis.

59. A robotic system for managing objects, the system comprising:
an arm assembly, the arm assembly having at least 4 degrees of freedom; and an end of arm tool (EOAT) assembly, the EOAT assembly including:
a tool base subassembly, the tool base subassembly formed as an elongated body with a first end, a second end, a center region between the first and second ends of the tool base subassembly, and a rear axis formed through the elongated body of the tool base subassembly between the first and second ends of the tool base subassembly, the tool base subassembly secured to the arm assembly, the tool base subassembly including:
a first subassembly member connector;
a second subassembly member connector;
a first horizontal motion subsystem, the first horizontal motion subsystem configured to selectively move the first subassembly member connector between the first end of the tool base subassembly and the center region of the tool base subassembly;
a second horizontal motion subsystem, the second horizontal motion subsystem configured to selectively move the second subassembly member connector between the second end of the tool base subassembly and the center region of the tool base subassembly;
a first mechanized tool subassembly, the first mechanized tool subassembly formed as an elongated body with a front end, a rear end, a top end, a bottom end, and a first axis formed through the elongated body of the first mechanized tool subassembly between the front and rear ends of the first mechanized tool subassembly, the rear end of the first mechanized tool subassembly secured to the first subassembly member connector, the first mechanized tool subassembly configured to selectively move between the first end of the tool base subassembly and the center region of the tool base subassembly when the first horizontal motion subsystem selectively moves the first subassembly member connector between the first end of the tool base subassembly and the center region of the tool base subassembly, the first mechanized tool subassembly including:
a first holding member joint, the first holding member joint having a first end, a second end, and a first holding member joint axis formed between the first and second ends of the first holding member joint, the second end of the first holding member joint configured to rotate relative to the first holding member joint axis, wherein the first end of the first holding member joint is secured to a first portion of the bottom end of the first mechanized tool subassembly;
a first rotary subsystem, the first rotary subsystem configured to selectively rotate the second end of the first holding member joint relative to the first holding member joint axis;
a first holding member, the first holding member secured to the second end of the first holding member joint, the first holding member configured to rotate relative to the first holding member joint axis when the first rotary subsystem rotates the second end of the first holding member joint relative to the first holding member joint axis;
a second mechanized tool subassembly, the second mechanized tool subassembly formed as an elongated body with a front end, a rear end, a top end, a bottom end, and a second axis formed through the elongated body of the second mechanized tool subassembly between the front and rear ends of the second mechanized tool subassembly, the rear end of the second mechanized tool subassembly secured to the second subassembly member connector, the second mechanized tool subassembly configured to selectively move between the second end of the tool base subassembly and the center region of the tool base subassembly when the second horizontal motion subsystem selectively moves the second subassembly member connector between the second end of the tool base subassembly and the center region of the tool base subassembly.

60. The system of example 59, wherein the second mechanized tool subassembly includes:
a second holding member joint, the second holding member joint having a first end, a second end, and a second holding member joint axis formed between the first and second ends of the second holding member joint, the second holding member joint axis being parallel to the second axis, the second end of the second holding member joint configured to rotate relative to the second holding member joint axis, wherein the first end of the second holding member joint is secured to a first portion of the bottom end of the second mechanized tool subassembly;
a second rotary subsystem, the second rotary subsystem configured to selectively rotate the second end of the second holding member joint relative to the second holding member joint axis;
a second holding member, the second holding member secured to the second end of the second holding member joint, the second holding member configured to rotate relative to the second holding member joint axis when the second rotary subsystem rotates the second end of the second holding member joint relative to the second holding member joint axis.

61. The system of any one of examples 59-60, wherein the elongated body of the first mechanized tool subassembly is formed as a planar body; wherein the elongated body of the second mechanized tool subassembly is formed as a planar body; and wherein the planar body of the first mechanized tool subassembly and the planar body of the second mechanized tool subassembly are parallel to one another.

62. The system of any one of examples 59-61, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly;
control the first rotary subsystem to selectively rotate the second end of the first holding member joint relative to the first holding member joint axis.

63. The system of example 60, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly;
control the first rotary subsystem to selectively rotate the second end of the first holding member joint relative to the first holding member joint axis;
control the second rotary subsystem to selectively rotate the second end of the second holding member joint relative to the second holding member joint axis.

64. The system of any one of examples 59-63, wherein the first mechanized tool subassembly further comprises:
a third holding member joint, the third holding member joint having a first end, a second end, and a third holding member joint axis formed between the first and second ends of the third holding member joint, the third holding member joint axis being parallel to the first axis, the second end of the third holding member joint configured to rotate relative to the third holding member joint axis, wherein the first end of the third holding member joint is secured to a second portion of the bottom end of the first mechanized tool subassembly;
a third rotary subsystem, the third rotary subsystem configured to selectively rotate the second end of the third holding member joint relative to the third holding member joint axis;
a third holding member, the third holding member secured to the second end of the third holding member joint, the third holding member configured to rotate relative to the third holding member joint axis when the third rotary subsystem rotates the second end of the third holding member joint relative to the third holding member joint axis.

65. The system of any one of examples 59-64, wherein the first mechanized tool subassembly further comprises:
a third holding member, the third holding member secured to the second end of the third holding member joint, the third holding member configured to rotate relative to the first holding member joint axis when the first rotary subsystem rotates the second end of the first holding member joint relative to the first holding member joint axis;
wherein the second end of the first holding member joint is formed as an elongated member having a front end and a rear end;
wherein the first holding member is secured to the front end of the elongated member of the second end of the first holding member joint; and
wherein the third holding member is secured to the rear end of the elongated member of the second end of the first holding member joint.

66. A robotic system for managing objects, the system comprising:
an arm assembly, the arm assembly having at least 4 degrees of freedom; and an end of arm tool (EOAT) assembly, the EOAT assembly including:
a tool base subassembly, the tool base subassembly formed as an elongated body with a first end, a second end, a center region between the first and second ends of the tool base subassembly, and a rear axis formed through the elongated body of the tool base subassembly between the first and second ends of the tool base subassembly, the tool base subassembly secured to the arm assembly, the tool base subassembly including:
a first subassembly member connector;
a second subassembly member connector;
a first horizontal motion subsystem, the first horizontal motion subsystem configured to selectively move the first subassembly member connector between the first end of the tool base subassembly and the center region of the tool base subassembly;
a second horizontal motion subsystem, the second horizontal motion subsystem configured to selectively move the second subassembly member connector between the second end of the tool base subassembly and the center region of the tool base subassembly;
a first mechanized tool subassembly, the first mechanized tool subassembly formed as an elongated body with a front end, a rear end, a top end, a bottom end, and a first axis formed through the elongated body of the first mechanized tool subassembly between the front and rear ends of the first mechanized tool subassembly, the rear end of the first mechanized tool subassembly secured to the first subassembly member connector, the first mechanized tool subassembly configured to selectively move between the first end of the tool base subassembly and the center region of the tool base subassembly when the first horizontal motion subsystem selectively moves the first subassembly member connector between the first end of the tool base subassembly and the center region of the tool base subassembly, the first mechanized tool subassembly including:
a first holding member joint, the first holding member joint having a first end, a second end, and a first holding member joint axis formed between the first and second ends of the first holding member joint, the second end of the first holding member joint configured to rotate relative to the first holding member joint axis, wherein the first end of the first holding member joint is secured to a first portion of the bottom end of the first mechanized tool subassembly;
a first rotary subsystem, the first rotary subsystem configured to selectively rotate the second end of the first holding member joint relative to the first holding member joint axis;
a first holding member, the first holding member secured to the second end of the first holding member joint, the first holding member configured to rotate relative to the first holding member joint axis when the first rotary subsystem rotates the second end of the first holding member joint relative to the first holding member joint axis;
a first opening formed through the elongated body of the first mechanized tool subassembly;
a first lifting member, the first lifting member formed as a cylindrical body rotatable relative to a first lifting axis, the first lifting axis formed through the cylindrical body of the first lifting member, the first lifting member secured to the first mechanized tool subassembly in such a way that at least a portion of the cylindrical body of the first lifting member protrudes through the first opening; and a first lifting member rotary subsystem, the first lifting member rotary subsystem configured to selectively rotate the cylindrical body of the first lifting member relative to the first lifting axis;
a second mechanized tool subassembly, the second mechanized tool subassembly formed as an elongated body with a front end, a rear end, a top end, a bottom end, and a second axis formed through the elongated body of the second mechanized tool subassembly between the front and rear ends of the second mechanized tool subassembly, the rear end of the second mechanized tool subassembly secured to the second subassembly member connector, the second mechanized tool subassembly configured to selectively move between the second end of the tool base subassembly and the center region of the tool base subassembly when the second horizontal motion subsystem selectively moves the second subassembly member connector between the second end of the tool base subassembly and the center region of the tool base subassembly.

67. The system of example 66, wherein the first mechanized tool subassembly further comprises:
a first lifting assist member, the first lifting assist member formed as a planar body with an outer surface and an inner surface opposite to the outer surface, the first lifting assist member secured to the first mechanized tool subassembly in such a way that the inner surface of the first lifting assist member is in contact with at least an outer surface of the cylindrical body of the first lifting member;
wherein, when the cylindrical body of the first lifting member rotates, the first lifting assist member is configured to move along with the rotation of the cylindrical body of the first lifting member.

68. The system of any one of examples 66-67, wherein the second mechanized tool subassembly includes:
a second opening formed through the elongated body of the second mechanized tool subassembly;
a second lifting member, the second lifting member formed as a cylindrical body rotatable relative to a second lifting axis, the second lifting axis formed through the cylindrical body of the second lifting member and parallel to the second axis, the second lifting member secured to the second mechanized tool subassembly in such a way that at least a portion of the cylindrical body of the second lifting member protrudes through the second opening; and
a second lifting member rotary subsystem, the second lifting member rotary subsystem configured to selectively rotate the cylindrical body of the second lifting member relative to the second lifting axis.

69. The system of example 68, wherein the second mechanized tool subassembly further comprises:
a second lifting assist member, the second lifting assist member formed as a planar body with an outer surface and an inner surface opposite to the outer surface, the second lifting assist member secured to the second mechanized tool subassembly in such a way that the inner surface of the second lifting assist member is in contact with at least an outer surface of the cylindrical body of the second lifting member;
wherein, when the cylindrical body of the second lifting member rotates, the second lifting assist member is configured to move along with the rotation of the cylindrical body of the second lifting member.

70. The system of any one of examples 66-69, wherein the cylindrical body of the first lifting member rotates in a first direction; and wherein the cylindrical body of the second lifting member rotates in a second direction opposite to the first direction.

71. The system of any one of examples 66-70, wherein the elongated body of the first mechanized tool subassembly is formed as a planar body; wherein the elongated body of the second mechanized tool subassembly is formed as a planar body; and wherein the planar body of the first mechanized tool subassembly and the planar body of the second mechanized tool subassembly are parallel to one another.

72. The system of any one of examples 66-71, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly;
control the first lifting member rotary subsystem to selectively rotate the cylindrical body of the first lifting member relative to the first lifting axis; and control the first rotary subsystem to selectively rotate the second end of the first holding member joint relative to the first holding member joint axis.

73. The system of example 68, further comprising a main controller, the main controller configurable to perform at least one of the following:
control the first horizontal motion subsystem to selectively move the first subassembly member connector between the first end of the tool base subassembly and the center region of the tool base subassembly;
control the second horizontal motion subsystem to selectively move the second subassembly member connector between the second end of the tool base subassembly and the center region of the tool base subassembly;
control the first lifting member rotary subsystem to selectively rotate the cylindrical body of the first lifting member relative to the first lifting axis;
control the second lifting member rotary subsystem to selectively rotate the cylindrical body of the second lifting member relative to the second lifting axis;
control the first rotary subsystem to selectively rotate the second end of the first holding member joint relative to the first holding member joint axis; and
control the second rotary subsystem to selectively rotate the second end of the second holding member joint relative to the second holding member joint axis.

74. The system of any one of examples 66-73, wherein the first mechanized tool subassembly further comprises:
a third opening formed through the elongated body of the first mechanized tool subassembly; a third lifting member, the third lifting member formed as a cylindrical
body rotatable relative to a third lifting axis, the third lifting axis formed through the cylindrical body of the third lifting member and parallel to the first axis, the third lifting member secured to the first mechanized tool subassembly in such a way that at least a portion of the cylindrical body of the third lifting member protrudes through the third opening;
a third lifting assist member, the third lifting assist member formed as a planar body with an outer surface and an inner surface opposite to the outer surface, the third lifting assist member secured to the first mechanized tool subassembly in such a way that the inner surface of the third lifting assist member is in contact with at least an outer surface of the cylindrical body of the third lifting member;
wherein, when the cylindrical body of the third lifting member rotates, the third lifting assist member is configured to move along with the rotation of the cylindrical body of the third lifting member.

75. The system of any one of examples 66-74, wherein the first mechanized tool subassembly further comprises:
a third lifting member rotary subsystem, the third lifting member rotary subsystem configured to selectively rotate the cylindrical body of the third lifting member relative to the third lifting axis.

76. The system of any one of examples 66-75, wherein the first lifting member rotary subsystem is further configured to selectively rotate the cylindrical body of the third lifting member relative to the third lifting axis.

In the specification, there have been disclosed certain embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. An EOAT assembly, comprising:
a tool base subassembly having a tool base attachment surface;
a first mechanized tool subassembly movably attached to the tool base subassembly along the tool base attachment surface, the first mechanized tool subassembly including:
a first elongated body oriented orthogonally relative to the tool base attachment surface, and
a first holding member attached to the first elongated body, the first holding member having an engaged position to pass beneath an object to assist with lifting of the object and a disengaged position that does not contribute to lifting of the object;
a second mechanized tool subassembly movably attached to the tool base subassembly along the tool base attachment surface, the second mechanized tool subassembly including:
a second elongated body oriented orthogonally relative to the tool base attachment surface, and
a second holding member attached to the second elongated body, the second holding member having an engaged position to pass beneath an object to assist with lifting of the object and a disengaged position that does not contribute to lifting of the object;
wherein movement of first and second mechanized tool assemblies along the tool base attachment surface provides for opening and partially closing of a gap there between to laterally provide space for engaging with the object followed by squeezing the object for lifting.

2. The EOAT assembly of claim 1, wherein the tool base subassembly is connected to an arm assembly of an object managing system.

3. The EOAT assembly of claim 1, further comprising a first horizontal motion subsystem to selectively move the first elongated body along the tool base attachment surface between a first end of the tool base subassembly toward a center region of the tool base subassembly.

4. The EOAT assembly of claim 3, further comprising a second horizontal motion subsystem to selectively move the second elongated body along the tool base attachment surface between a second end of the tool base subassembly toward the center region of the tool base subassembly.

5. The EOAT assembly of claim 1, further comprising a first holding member joint connecting the first elongated body to the first holding member, wherein articulation of the first holding member joint transitions the first holding member between its engaged position and it disengaged position.

6. The EOAT assembly of claim 5, further comprising a second holding member joint connecting the second elongated body to the second holding member, wherein articulation of the second holding member joint transitions the second holding member between its engaged position and it disengaged position.

7. The EOAT assembly of claim 1, further comprising a first lifting member secured to the first elongated body and adjacent to a first opening through the first elongated body, wherein the first lifting member is movable relative to the first opening to protrude or protrude further through the first opening, or to cause a first lifting assist member to protrude or protrude further into the gap to assist with object engagement for lifting.

8. The EOAT assembly of claim 7, wherein rotation of the first lifting member causes the first lifting assist member to protrude or protrude further into the gap.

9. The EOAT assembly of claim 7, further comprising a second lifting member secured to the second elongated body and adjacent to a second opening through the second elongated body, wherein the second lifting member is movable relative to the second opening to protrude or protrude further through the second opening, or to cause a second lifting assist member to protrude or protrude further into the gap to assist with object engagement for lifting.

10. The EOAT assembly of claim 9, wherein rotation of the second lifting member causes the second lifting assist member to protrude or protrude further into the gap.

11. A robotic system for managing objects, comprising:
an EOAT assembly including holding members having an engaged position to pass beneath an object to assist with lifting of the object and a disengaged position that does not contribute to lifting of the object; and
a conveyer system including:
a plurality of conveyer belt supports to support objects placed thereon,
conveyer belt support spacing between adjacent conveyer belt supports, wherein the conveyer belt support spacing is configured to receive holding members in both the engaged and the disengaged position such that the holding members may be placed beneath the objects on the conveyer belt supports for lifting;
at least one rotatable drive member, and
a conveyer belt engaged with the rotatable drive member to generate conveyer belt movement along a working surface of the conveyer belt, wherein the conveyer belt passes over the plurality of conveyer belt supports and wherein the conveyer belt is narrower in a direction orthogonal to the direction of belt movement compared to the conveyer belt supports to provide access for the holding members into the conveyer belt support spacing.

12. The robotic system of claim 11, wherein the EOAT assembly further includes a pair of mechanized tool assemblies to provide coordinated lateral movement for opening a gap there between to laterally provide space for engaging with an object and partially closing the gap to squeeze the object for lifting.

13. The robotic system of claim 12, wherein the pair of mechanized tool assemblies each include at least one of the holding members associated therewith, wherein lifting is configured to occur when the pair of mechanized tool assemblies is squeezing the object laterally and the holding members are in the engaged position beneath the object.

14. The robotic system of claim 12, further comprising a tool base subassembly, wherein the pair of mechanized tool assemblies are each connected orthogonally to the tool base subassembly for lateral translation along a tool base attachment surface of the tool base assembly causes the opening and partial closing of the gap.

15. The robotic system of claim 11, wherein one or both of the pair of mechanized tool assemblies include an opening therethrough for engagement of a lifting member or a lifting assist member as one or both protrude or protrude further into the gap.

16. The robotic system of claim 11, wherein the EOAT assembly is rotationally connected to an arm assembly.

17. The robotic system of claim 16, wherein the arm assembly includes multiple arm segments and multiple arm joints to provide three-dimensional manipulation of the EOAT assembly.

18. The robotic system of claim 17, wherein the arm assembly is also connected at or near at an opposite end thereof to an arm assembly connector of vertical assembly to provide vertical movement of the arm assembly.

19. The robotic system of claim 18, wherein the vertical assembly is rotational attached to a support base.

20. The robotic system of claim 19, wherein the support base is on a mobile vehicle.

21. The robotic system of claim 11, further comprising a second EOAT assembly.

22. The robotic system of claim 21, wherein the second EOAT assembly includes holding members having an engaged position to pass beneath an object to assist with lifting of the object and a disengaged position that does not contribute to lifting of the object.

23. The robotic system of claim 21, wherein the EOAT assembly includes a pair of mechanized tool assemblies to provide coordinated lateral movement for opening a gap there between to laterally provide space for engaging with an object and partially closing the gap to squeeze the object for lifting.

24. The robotic system of claim 23, wherein one or both of the pair of mechanized tool assemblies include an opening therethrough for engagement of a lifting member or a lifting assist member as one or both protrude or protrude further into the gap.

25. The robotic system of claim 21, wherein the EOAT assembly and the second EOAT assembly are configured as mirror images of one another.

26. The robotic system of claim 21, wherein the EOAT assembly and the second EOAT assembly both positioned on a mobile vehicle.

27. A method of managing objects, comprising:
identifying an object on a surface to be manipulated by an EOAT assembly of a robotic system;
orienting a pair mechanized tool subassemblies about an object, wherein the pair of mechanized tool subassemblies each include one or more holding members having an engaged position and a disengaged position, wherein prior to engaging the object, the holding members are in the disengaged position;
squeezing the object between the pair of mechanized tool subassemblies;
moving the holding members from the disengaged position to the engaged position;
manipulating the object while squeezed between the pair of mechanized tool subassemblies and while the holding members are positioned beneath the object to provide support thereto.

28. The method of claim 27, wherein the EOAT assembly further includes a tool base subassembly having a tool base attachment surface, wherein squeezing the object occurs by coordinated lateral movement of the pair of mechanized tool subassemblies to partially closing a gap there between.

29. The method of claim 28, wherein the pair of mechanized tool subassemblies each include at least one of the holding members associated therewith, wherein manipulating the object occurs when the pair of mechanized tool subassemblies is squeezing the object laterally and the holding members are in the engaged position beneath the object.

30. The method of claim 27, wherein the EOAT assembly further comprises a tool base subassembly, wherein the pair of mechanized tool assemblies are each connected orthogonally to the tool base subassembly for lateral translation along a tool base attachment surface of the tool base assembly causes the opening and partial closing of the gap.

31. The method claim 27, wherein one or both of the pair of mechanized tool assemblies include an opening therethrough, wherein manipulating the object is assisted by engagement of a lifting member or a lifting assist member as one or both protrude or protrude further into the gap.

32. The method of claim 27, wherein orienting the pair of mechanized tool subassemblies includes rotating the EOAT assembly relative to an arm assembly.

33. The method of claim 27, wherein orienting the pair of mechanized tool subassemblies includes moving multiple arm segments of the arm assembly at arm joints.

34. The method of claim 27, wherein orienting the pair of mechanized tool subassemblies includes moving the arm assembly vertically along a vertical assembly.

35. The method of claim 34, wherein orienting the pair of mechanized tool subassemblies includes rotating the vertical assembly relative to a support base.

36. The method of claim 27, wherein orienting the pair of mechanized tool subassemblies includes:
rotating the EOAT assembly relative to an arm assembly,
moving multiple arm segments of the arm assembly at arm joints,
moving the arm assembly vertically along a vertical assembly, and
rotating the vertical assembly relative to a support base, to provide three-dimensional manipulation of the EOAT assembly.

37. The method of claim 27, wherein the EOAT assembly is connected to a mobile vehicle, and wherein orienting the pair of mechanized tool subassemblies includes moving the mobile vehicle in proximity to one or more objects to be manipulated.
